(19) United States
(12) Patent Application Publication
(10) Pub. No.: US 2026/0356629 A1
(43) Pub. Date: Nov. 12, 2026

(54) CABLE ARRANGING AND WINDING MECHANISM AND OUTPUT DEVICE

(71) Applicant: Beyond Power Inc., Shenzhen (CN)

(72) Inventors: Changxing ZHOU, Shenzhen (CN); Sirong HUANG, Shenzhen (CN); Juncheng CHEN, Shenzhen (CN); Hongtao PAN, Shenzhen (CN); Hang YIN, Shenzhen (CN); Jiale HE, Shenzhen (CN); Jiahao YI, Shenzhen (CN); Jiehong MAI, Shenzhen (CN); Qianbin ZUO, Shenzhen (CN)

(73) Assignee: Beyond Power Inc., Shenzhen (CN)

(21) Appl. No.: 19/718,018

(22) Filed: Jun. 24, 2026

(30) Foreign Application Priority Data
Feb. 21, 2023 (CN) 202310172558.7
Feb. 21, 2023 (CN) 202310180437.7
Feb. 21, 2023 (CN) 202310186423.6
Feb. 21, 2023 (CN) 202310203074.4
Feb. 21, 2023 (CN) 202320346128.8
Feb. 21, 2023 (CN) 202320356894.2
Feb. 21, 2023 (CN) 202320364243.8
Feb. 21, 2023 (CN) 202320391256.4
Jul. 17, 2023 (CN) 202321879489.5
Sep. 28, 2023 (CN) 202322680388.1

(51) Int. Cl. B65H 75/44; B65H 75/26

(52) U.S. Cl. CPC B65H 75/4486; B65H 75/265; B65H 2553/22

(57) ABSTRACT

A cable arranging and winding mechanism and an output device. The cable arranging and winding mechanism includes: a cable housing; a winding reel, rotatably disposed on the cable housing, and configured to receive a cable wound by the winding reel; a cable-arranging assembly, pivotably disposed on the cable housing, and configured for the cable wound around the winding reel to pass through, where the cable is movable with the cable-arranging assembly; a cable outlet, disposed on the cable housing, and configured for the cable passing through the cable-arranging assembly to pass out; and a linkage assembly or a power actuator, where the linkage assembly is connected to the winding reel and the cable-arranging assembly, the linkage assembly is configured to link the winding reel and the cable-arranging assembly, and the power actuator is configured to drive the cable-arranging assembly to pivot.

### CROSS-REFERENCE TO RELATED APPLICATIONS

The present application is a continuation application of the U.S. patent application Ser. No. 19/158,453, filed on Aug. 21, 2025. The U.S. patent application Ser. No. 19/158,453 is a National Stage of International Patent Application No. PCT/CN2024/077946, filed on Feb. 21, 2024, which claims the benefit of priority to Chinese Patent Application No. 202310172558.7, filed on Feb. 21, 2023, and Chinese Patent Application No. 202310180437.7, filed on Feb. 21, 2023, and Chinese Patent Application No. 202310203074.4, filed on Feb. 21, 2023, and Chinese Patent Application No. 202310186423.6, filed on Feb. 21, 2023, and Chinese Patent Application No. 202320356894.2, filed on Feb. 21, 2023, and Chinese Patent Application No. 202320346128.8, filed on Feb. 21, 2023, and Chinese Patent Application No. 202320391256.4, filed on Feb. 21, 2023, and Chinese Patent Application No. 202320364243.8, filed on Feb. 21, 2023, and Chinese Patent Application No. 202321879489.5, filed on Jul. 17, 2023, and Chinese Patent Application No. 202322680388.1, filed on Sep. 28, 2023, all of which are incorporated by reference herein.

### TECHNICAL FIELD

The present disclosure relates to the technical field of output devices, and in particular, to a cable arranging and winding mechanism and an output device.

### BACKGROUND ART

Cable-type output devices are a widely used category of output devices. This type of device usually applies resistance or power to a cable. During use, a user exercises by reciprocally pulling the cable or being driven by the cable. The cable-type output device uses a reel as a storage device for the cable. A cable head of the cable is generally fixed to an end portion of a side of the reel, and then the cable can be wound around an axial direction of the reel, which facilitates retraction and release of the cable.

### SUMMARY OF THE DISCLOSURE

The present disclosure provides a cable arranging and winding mechanism and an output device.

According to a first aspect of the present disclosure, the cable arranging and winding mechanism according to some embodiments of the present disclosure includes: a cable housing; a winding reel, rotatably disposed on the cable housing, and configured to receive a cable wound by the winding reel; a cable-arranging assembly, pivotably disposed on the cable housing, and configured for the cable wound around the winding reel to pass through, where the cable is movable with the cable-arranging assembly; a cable outlet, disposed on the cable housing, and configured for the cable passing through the cable-arranging assembly to pass out; and a linkage assembly or a power actuator, where the linkage assembly is connected to the winding reel and the cable-arranging assembly, the linkage assembly is configured to link the winding reel and the cable-arranging assembly, and the power actuator is configured to drive the cable-arranging assembly to pivot.

According to a second aspect of the present disclosure, the cable arranging and winding mechanism according to some embodiments of the present disclosure includes: a cable housing, defining a cable outlet; a winding reel, rotatably disposed on the cable housing, and configured to be wound by the cable; and a cable-arranging assembly, configured to pivot driven by a linkage assembly or a power actuator; where the cable-arranging assembly includes a pivoting seat, a cable-guiding arm, and a guiding assembly, the pivoting seat is rotatably arranged on the cable housing to rotate about the cable outlet, the cable-guiding arm is connected to the pivoting seat, and the guiding assembly is disposed on the cable-guiding arm; the cable is configured to pass through the guiding assembly and exit from the cable outlet; and the guiding assembly is configured to move synchronously with a position where the cable is released from the winding reel or a position where the cable is wound on the winding reel.

According to a third aspect of the present disclosure, the output device according to some embodiments of the present disclosure includes: a cable arranging and winding mechanism, including: a cable housing; a winding reel, rotatably disposed on the cable housing, and configured to receive a cable wound by the winding reel; a cable-arranging assembly, pivotably disposed on the cable housing, and configured for the cable wound around the winding reel to pass through, where the cable is movable with the cable-arranging assembly; a cable outlet, disposed on the cable housing, and configured for the cable passing through the cable-arranging assembly to pass out; and a linkage assembly or a power actuator, where the linkage assembly is connected to the winding reel and the cable-arranging assembly, the linkage assembly is configured to link the winding reel and the cable-arranging assembly, and the power actuator is configured to drive the cable-arranging assembly to pivot; a power source, configured to apply power or resistance to the winding reel; and the cable, wound around the winding reel, where an end portion of the cable is configured to pass through the cable-arranging assembly and exit from the cable outlet.

Additional aspects and advantages of the present disclosure will be partly given in the following description, and partly will become apparent from the following description, or will be learned through the practice of the present disclosure.

### BRIEF DESCRIPTION OF THE DRAWINGS

The above and/or additional aspects and advantages of the present disclosure will become apparent and easily understood from the description of the embodiments in conjunction with the accompanying drawings.

FIG. 1 is a perspective structural view of an output device according to some embodiments of the present disclosure.

FIG. 2 is a perspective structural view of a cable housing according to some embodiments of the present disclosure.

FIG. 3 is a perspective structural view of a power supply assembly according to some embodiments of the present disclosure.

FIG. 4 is an exploded view of a partial structure of an output device according to some embodiments of the present disclosure.

FIG. 5 is a perspective structural view of an output device according to some embodiments of the present disclosure.

FIG. 6 is a partial enlarged view of portion A in FIG. 5.

FIG. 7 is a perspective structural view of an output device according to some embodiments of the present disclosure.

FIG. 8 is a partial enlarged view of portion B in FIG. 7.

FIG. 9 is a system block diagram of an output device according to some embodiments of the present disclosure.

FIG. 10 is a schematic diagram of a connection between a connecting structure and a base according to some embodiments of the present disclosure.

FIG. 11 is a schematic diagram of a connection between a connecting structure and a base according to some embodiments of the present disclosure.

FIG. 12 is a system block diagram of an output device according to some embodiments of the present disclosure.

FIG. 13 is a system block diagram of an output device according to some embodiments of the present disclosure.

FIG. 14 is a system block diagram of an output device according to some embodiments of the present disclosure.

FIG. 15 is a system block diagram of an output device according to some embodiments of the present disclosure.

FIG. 16 is a schematic diagram of combination scenarios of an output device according to some embodiments.

FIG. 17 is a structural view of a heat dissipation cover according to an embodiment of the present disclosure.

FIG. 18 is a structural view of a locking apparatus according to an embodiment of the present disclosure.

FIG. 19 is a schematic diagram of an output device according to some embodiments of the present disclosure.

FIG. 20 is a perspective structural view of a winding reel according to some embodiments of the present disclosure.

FIG. 21 is an exploded structural view of a winding reel according to some embodiments of the present disclosure.

FIG. 22 is a sectional structural view of a winding reel according to some embodiments of the present disclosure.

FIG. 23 is a structural view of an inner core and a winding reel housing according to some embodiments of the present disclosure.

FIG. 24 is a structural view of a split inner core according to some embodiments of the present disclosure.

FIG. 25 is a schematic diagram of an output device according to some embodiments of the present disclosure.

FIG. 26 is a perspective structural view of a winding reel according to some embodiments of the present disclosure.

FIG. 27 is an exploded structural view of a winding reel according to some embodiments of the present disclosure.

FIG. 28 is an enlarged view of portion IV of a winding reel in FIG. 27.

FIG. 29 is a perspective structural view of a cable-pressing member according to some embodiments of the present disclosure.

FIG. 30 is an overall structural view of a winding apparatus according to an embodiment of the present disclosure.

FIG. 31 is an exploded view of a winding apparatus according to an embodiment of the present disclosure.

FIG. 32 is an overall structural view of a winding disc according to an embodiment of the present disclosure.

FIG. 33 is a schematic diagram of a cable wound on a winding disc according to an embodiment of the present disclosure.

FIG. 34 is another overall structural view of a winding disc according to an embodiment of the present disclosure.

FIG. 35 is another schematic diagram of a cable wound on a winding disc according to an embodiment of the present disclosure.

FIG. 36 is an overall structural view of a protective cover according to an embodiment of the present disclosure.

FIG. 37 is an overall structural view of a winding disc according to another embodiment of the present disclosure.

FIG. 38 is an overall structural view of a winding disc according to another embodiment of the present disclosure.

FIG. 39 is a structural view of a pivoting cable-arranging scheme according to some embodiments of the present disclosure.

FIG. 40 is a schematic diagram of a linkage assembly of the pivoting cable-arranging scheme according to some embodiments of the present disclosure.

FIG. 41 is a schematic diagram of the pivoting cable-arranging scheme and a guiding assembly according to some embodiments of the present disclosure.

FIG. 42 is a schematic diagram of the guiding assembly and an angle detection apparatus according to one embodiment of the present disclosure.

FIG. 43 is a schematic diagram of the guiding assembly and the angle detection apparatus according to another embodiment of the present disclosure.

FIG. 44 is a structural view of a sliding cable-arranging scheme according to some embodiments of the present disclosure.

FIG. 45 is an internal structural view of the sliding cable-arranging scheme according to some embodiments of the present disclosure.

FIG. 46 is a schematic diagram of a cable-guiding assembly of the sliding cable-arranging scheme according to some embodiments of the present disclosure.

FIG. 47 is a schematic diagram of a cable-arranging assembly driven by a power actuator according to some embodiments of the present disclosure.

FIG. 48 is a schematic diagram of a cable-arranging assembly driven by a linkage assembly according to some embodiments of the present disclosure.

FIG. 49 is a schematic diagram of an output device with a universal cable outlet assembly according to an embodiment of the present disclosure.

FIG. 50 is a schematic diagram of a universal cable outlet assembly according to an embodiment of the present disclosure, and a direction of a double arrow in the figure is a first direction.

FIG. 51 is a perspective view of a universal cable outlet assembly according to an embodiment of the present disclosure.

FIG. 52 is an exploded view of a universal cable outlet assembly according to an embodiment of the present disclosure.

FIG. 53 is a schematic diagram of a universal cable outlet assembly according to another embodiment of the present disclosure, and a direction of a double arrow in the figure is a first direction.

FIG. 54 is a perspective view of a universal cable outlet assembly according to another embodiment of the present disclosure.

FIG. 55 is an exploded view of a universal cable outlet assembly according to another embodiment of the present disclosure.

FIG. 56 is a schematic diagram of a cable outlet seat covering a cable outlet wheel according to an embodiment of the present disclosure.

FIG. 57 is a schematic diagram of a rotating base and a cable outlet seat according to an embodiment of the present disclosure.

FIG. 58 is a schematic diagram of a cable outlet seat according to an embodiment of the present disclosure.

FIG. 59 is a structural view of a motor according to some embodiments of the present disclosure.

### DETAILED DESCRIPTION OF EMBODIMENTS

Embodiments of the present disclosure are described in detail below, and examples of the embodiments are shown in accompanying drawings, and the same or similar reference numerals represent the same or similar elements or elements having the same or similar functions. The embodiments described below with reference to the accompanying drawings are illustrative and are intended to explain the present disclosure and should not be construed as limiting the present disclosure.

In the description of the present disclosure, it should be understood that terms such as “center”, “longitudinal”, “transverse/lateral”, “length”, “width”, “thickness”, “up”, “down”, “front”, “back”, “left”, “right”, “vertical”, “horizontal”, “top”, “bottom”, “inner”, “outer”, “clockwise”, “counterclockwise”, etc., indicate orientations or positional relationships based on orientations or positional relationships shown in the accompanying drawings. These terms are used only for the convenience of describing the present disclosure and simplifying the description, and are not intended to indicate or imply that an apparatus or an element must have a specific orientation, be constructed and operated in a specific orientation, and therefore should not be construed as limiting the present disclosure. Additionally, terms such as “first” and “second” are used for descriptive purposes only and should not be construed as indicating or implying relative importance or implicitly indicating the number of technical features. Thus, features defined by “first” and “second” may explicitly or implicitly include one or more of the features. In the description of the present disclosure, the term “plurality of” means two or more, unless otherwise clearly and specifically defined.

In the description of the present disclosure, it should be noted that unless otherwise defined explicitly and specifically, terms such as “mount”, “connect”, “connection” should be understood broadly. For example, “connection” may be a fixed connection, a detachable connection, or an integral connection; or may be a mechanical connection, an electrical connection, or mutual communication; or may be a direct connection or an indirect connection through an intermediate media, or may be an internal connection of two elements or an interaction relationship between two elements. For those having ordinary skill in the art, specific meanings of the foregoing terms in the present disclosure may be understood according to specific situations.

In the present disclosure, unless otherwise defined explicitly and specifically, a first feature being “above” or “below” a second feature may include the first feature and the second feature being in direct contact, or may include the first and second features not being in direct contact but being in contact by using an additional feature between them. Moreover, a first feature being “above”, “upward”, and “on” a second feature may include the first feature being directly above and obliquely above the second feature, or only indicate that the first feature has a higher horizontal height than the second feature. A first feature being “below”, “beneath” and “underneath” the second feature includes the first feature being directly below and obliquely below the second feature, or only indicate that the first feature has a smaller horizontal height than the second feature. The term “and/or” is used to describe an association relationship for describing associated objects and represents that three relationships may exist. For example, A and/or B may represent the following three cases: Only A exists, both A and B exist, and only B exists. A, B may be singular or plural. The character “/” generally indicates an “or” relationship between the associated objects.

The following disclosure provides many different embodiments or examples to implement different structures of the present disclosure. To simplify the disclosure of the present disclosure, components and arrangements of specific embodiments are described below. Of course, these are only examples and are not intended to limit the present disclosure. Additionally, the present disclosure may repeat reference numerals and/or reference letters in different embodiments for the purpose of simplicity and clarity, which does not indicate a relationship between the various embodiments and/or arrangements discussed. Furthermore, the present disclosure provides embodiments of various specific processes and material, but those having ordinary skill in the art may be aware of the application of other processes and/or the use of other materials.

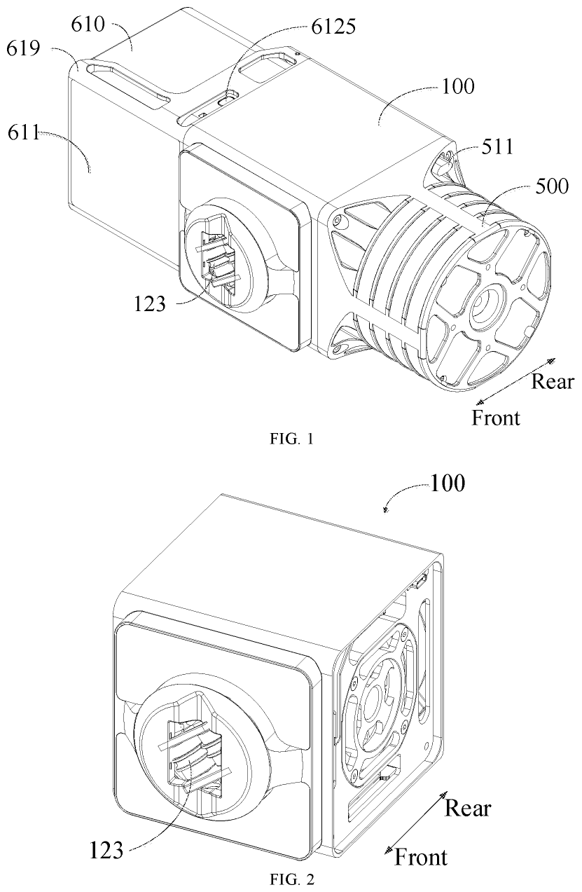

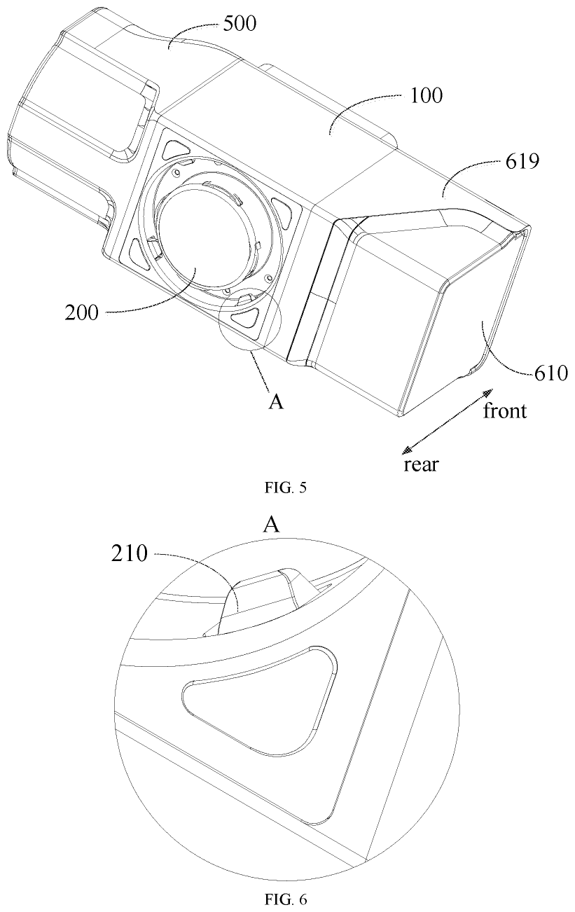

Referring to FIGS. 1-7, the output device in an embodiment of the present disclosure includes: a cable housing 100; a connecting structure 200, arranged at a rear side of the cable housing 100, and configured to be fixedly connected to a base 400, where a cable 900 in the cable housing 100 is configured to exit from a front side of the cable housing 100; a motor 500, fixedly connected to the cable housing 100 and configured to provide a traction force for the cable 900; and a power supply assembly 600, fixedly connected to the cable housing 100 and configured to supply power to the motor 500.

In an embodiment of the present disclosure, the rear side of the cable housing 100 is fixedly connected to the base 400 via the connecting structure 200, and the cable 900 is configured to exit from the front side of the cable housing 100. Thus, a lever arm may be shortened when the cable 900 is subjected to a force, so as to reduce a torque borne by the cable housing 100, which not only reduces the requirement of the strength of the cable housing 100, but also facilitates more stable fixation of the cable housing 100 on the base 400.

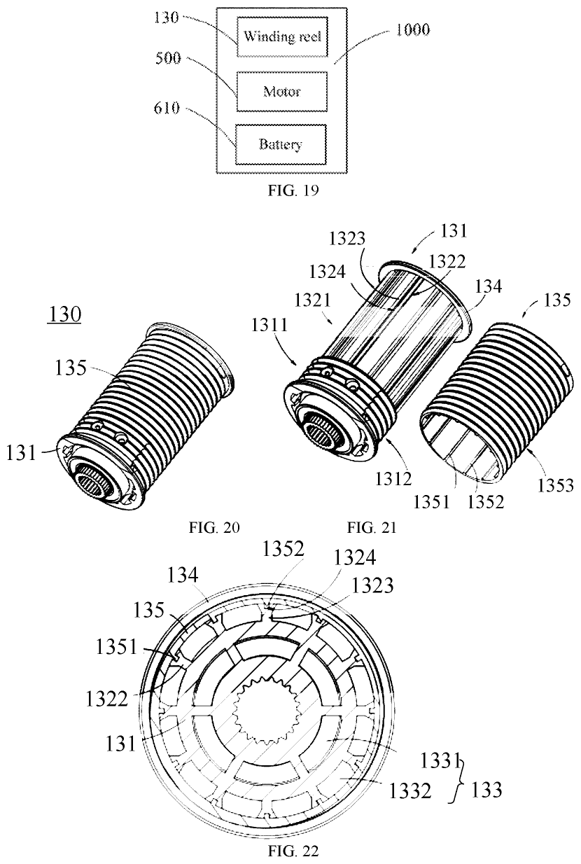

In some embodiments, the motor 500 may be fixed to the cable housing 100 by a bolt. For example, a reel, i.e., a winding reel 130 as shown in FIGS. 19-20, 25-26, 30, 39-40 and 44-48, connected to an output shaft of the motor 500 may be arranged in the cable housing 100. The cable 900 is wound around the reel and may exit from the cable housing 100 via a cable outlet wheel 123, such as a cable outlet wheel, on the front side of the cable housing 100. A torque of the motor 500 may be transmitted to the reel to achieve a traction function.

In some embodiments, the motor 500 is connected to the cable housing 100 via a detachable connection or a quick-release connection. The power supply assembly 600 is connected to the cable housing 100 via a detachable connection or a quick-release connection. In some embodiments, the motor 500 includes a series motor set 580, and the series motor set 580 includes a plurality of sub-motors 581 with power shafts connected end to end. With a detachable connection between the motor 500 and the series motor set 580, a user may reasonably series-connect a suitable number of sub-motors 581 according to the user's needs. Power shafts of adjacent sub-motors 581 may be connected end-to-end, and both ends of the power shaft penetrate through the sub-motor 581 and are connected to adjacent motors 500, which may be connected via a coupling or via a spline 573. For example, both ends of the power shaft may be connected via a spline sleeve. Alternatively, one end of the power shaft may be configured with a spline hole while an opposite end of the power shaft is configured with the spline 573. At the same time, power supplies of the sub-motors 581 in the series motor set 580 will be connected in parallel.

In some embodiments, the power supply assembly 600 is fixedly connected to the cable housing 100 via the motor 500, and the motor 500 is located between the cable housing 100 and the power supply assembly 600. In some embodiments, the motor 500 may also be located between the cable housing 100 and the power supply assembly 600, the motor 500 provides a driving force for the cable housing 100, and the power supply assembly 600 supplies power to both the motor 500 and the cable housing 100. This layout allows a product to achieve more diverse configurations, meeting user needs. In some embodiments, the power supply assembly 600 includes one or more of a battery 610, a power adapter, a connector, and a wiring rack.

When the power supply assembly 600 is the power adapter or the connector, the user may directly connect the output device to power for use, which is suitable for more application scenarios. In some embodiments, the power supply assembly 600 may also be used in combination with the battery 610, that is, the user may connect the output device to power for use, and retain the battery 610, which can meet power supply needs when power is off or when the output device is carried out, or in other situations where electricity connection is unavailable. In some embodiments, the power supply assembly 600 may also be a power-connectable rack, such as a power-connectable gantry. At this time, the cable housing 100 and the motor 500 may be directly assembled on the gantry and connected to power, which is suitable for more application scenarios.

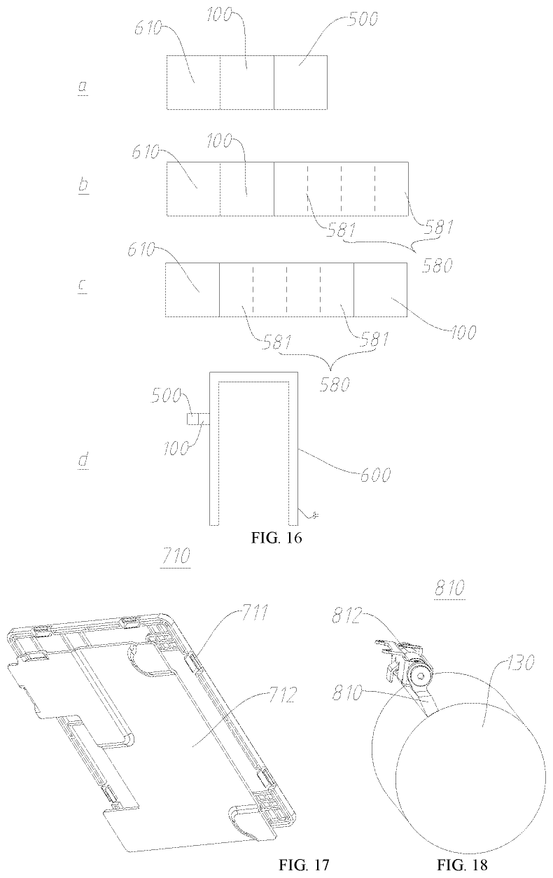

In some embodiments, as shown in FIG. 16, several possible combination scenarios are shown. FIG. 16a shows that the battery 610 and the motor 500 are located on both sides of the cable housing 100. FIG. 16b shows that the motor 500 is configured as a series motor set 580 with four sub-motors 581 connected in series. FIG. 16c shows that the series motor set 580 is located in the middle, with the battery 610 and the cable housing 100 on both sides of the series motor set 580 respectively. FIG. 16d shows that the power supply assembly 600 uses the power-connectable gantry, and the cable housing 100 and the motor 500 are connected sequentially to the power supply assembly 600. At this time, the connecting structure 200 of the cable housing 100 does not need to be fixed separately, and the gantry of the power supply assembly 600 may be configured to fix the output device.

In some embodiments, the motor 500 and the cable housing 100 are in communication with each other and define a heat dissipation channel; and/or, the cable housing 100 and the power supply assembly 600 are in communication with each other and define a heat dissipation channel; and/or, the motor 500 and the power supply assembly 600 are in communication with each other and define a heat dissipation channel.

In some embodiments, the heat dissipation channel actively dissipates heat through a heat dissipation fan 730, and the heat dissipation fan 730 is located in the heat dissipation channel.

After the motor 500, the cable housing 100, and the power supply assembly 600 are assembled, there are the heat dissipation channels in communication with each other, which may allow for ventilation and heat dissipation to help support continuous operation of the output device. For example, a channel in communication with the interior of a housing of the motor 500 may be left at a contact surface between the motor 500 and the cable housing 100, and a channel in communication with the interior of the cable housing 100 may be left at the contact surface between the cable housing 100 and the motor 500. When the motor 500 is connected to the cable housing 100, these two channels will also be in communication with each other to define the heat dissipation channel, and ventilation and heat dissipation will be performed simultaneously. In some embodiments, the heat dissipation fan 730 may also be provided to actively dissipate heat in the heat dissipation channel. The heat dissipation fan 730 may be specifically located on the cable housing 100, the motor 500, or the power supply assembly 600 and located in the heat dissipation channel.

In some embodiments, a heat dissipation cover 710 is provided on a shell 571 of the output device. A structural plate 711 can provide structural support for the heat dissipation cover 710, and the structural plate 711 has higher strength than the heat dissipation plate 712. The structural plate 711 has good thermal conductivity, and can absorb heat inside the shell 571 and transfer the heat outside the shell 571. In some embodiments, at least one heat dissipation hole 1331 is further defined on the structural plate 711 to conduct heat from the heat dissipation plate 712 to the outside. The heat dissipation plate 712 is located inside the structural plate 711. The heat dissipation plate 712 is detachably connected to the structural plate 711, to facilitate assembly and replacement. In some embodiments, the heat dissipation plate 712 is partially recessed inwardly to contact a heat-generating element in the shell 571, so as to better transfer heat to the outside. In some embodiments, the structural plate 711 includes a support portion inwardly at a position corresponding to an inward recess of the heat dissipation plate 712 to provide support, which may ensure close contact between the heat dissipation plate 712 and the heat-generating element while also transferring heat to the structural plate 711. For example, as shown in FIG. 17, the heat dissipation plate 712 and the structural plate 711 are connected by a snap-fit, and the heat dissipation plate 712 defines at least one inward recess according to a position of the heat-generating element in the shell 571, and the structural plate 711 includes the support portion at the corresponding position.

In some embodiments, a locking apparatus 810 is also provided. The locking apparatus 810 includes a movable locking arm 811. The locking arm 811 includes a first state in which the locking arm 811 contacts and presses against a locked shaft when power is off and a second state in which the locking arm 811 is away/distal from the locked shaft when power is on. The locked shaft 813 may be any winding reel 130 or any cable-guiding wheel (such as a cable-guiding pulley) through which the cable 900 passes, or a drive shaft or a motor shaft where the winding reel 130 is located, or any transmission shaft of a transmission assembly between the winding reel 130 and the motor 500. In some embodiments, when power is off, the locking arm 811 locks the locked shaft 813 via an elastic member 243, a magnetic member 1415, or a mechanical self-locking transmission assembly 814, or contacts and presses against the locked shaft 813 through friction self-locking; and/or, when power is on, the locking arm 811 may be away from the locked shaft 813 through a magnetic force of a locking electromagnet or a locking motor 812.

The output device also includes the locking apparatus 810, which is configured to lock any winding reel 130 or any cable-guiding wheel through which the cable 900 passes, or the drive shaft or the motor shaft where the winding reel 130 is located, or any transmission shaft of the transmission assembly between the winding reel 130 and the motor 500 when the device is de-energized, so as to help reduce the possibility of the winding reel 130 rotating and a load falling to ground when the load is suspended by the cable 900. At this time, the locking arm 811 is in the first state. The locking arm 811 of the locking apparatus 810 may be rotatably or slidably mounted. When the locking arm 811 is in the second state, the locking arm 811 rotates or slides away from the locked shaft 813 to stop locking, to allow the output device to operate normally. In some embodiments, the elastic member 243 or a groove configured to increase friction is provided on the contact surface between the locking arm 811 and the locked shaft 813.

In some embodiments, in the first state, a locking force exerted on the locking arm 811 is provided by an elastic force, or the magnetic force, or the mechanical self-locking transmission assembly 814. For example, the elastic force can be exerted by the elastic member 243, or the magnetic force can be exerted by the magnetic member 1415. The mechanical self-locking transmission assembly 814, such as a self-locking worm gear, can also be provided, so that the locking arm 811 can be driven by the transmission assembly to rotate and press against or leave the locked shaft 813, and cannot be driven by the locked shaft 813.

In some embodiments, in the first state, before power loss or prior to power-off, the locking motor 812 or the locking electromagnet drives the locking arm 811 to contact the locked shaft 813. At this time, a force exerted by the locking arm 811 on the transmission shaft is within a friction angle between the locking arm 811 and the transmission shaft or between the locking arm 811 and the winding reel 130, that is, the locking arm 811 can form a frictional self-locking with the transmission shaft or the winding reel 130. At this time, self-locking can be achieved without setting an additional external force, that is, after power loss or after power-off, the locking arm 811 may continue to lock the locked shaft 813 when the locking motor 812 or the electromagnet is de-energized.

In some embodiments, in the second state, the locking arm 811 is driven by the locking motor 812 or the electromagnet to rotate or slide away from the locked transmission shaft.

For example, as shown in FIG. 18, before power loss, the locking motor 812 drives the locking arm 811 to rotate into contact with the winding reel 130. After power loss, the locking motor 812 is de-energized, and the load drives the winding reel 130 via the cable 900. The rotation of the winding reel 130 further increases contact effect of the locking arm 811, thereby locking the winding reel 130. After the locking motor 812 is started, the locking motor 812 drives the locking arm 811 to rotate away from the winding reel 130, so as to release the lock.

For example, as shown in FIG. 59, before power loss, the locking motor 812 drives the locking arm 811 to rotate and press against the motor shaft (the locked shaft 813) via the mechanical self-locking transmission assembly 814. After power loss, since the mechanical self-locking transmission assembly 814 is a self-locking nut-and-screw transmission, a nut connected to the locking arm 811 cannot drive a screw to rotate, thereby maintaining a locking state. When power is supplied or when power-on, the locking motor 812 drives the locking arm 811 away from the motor shaft (the locked shaft 813) via the mechanical self-locking transmission assembly 814. Two locking arms 811 are provided to lock the motor shaft (the locked shaft 813) from two directions respectively.

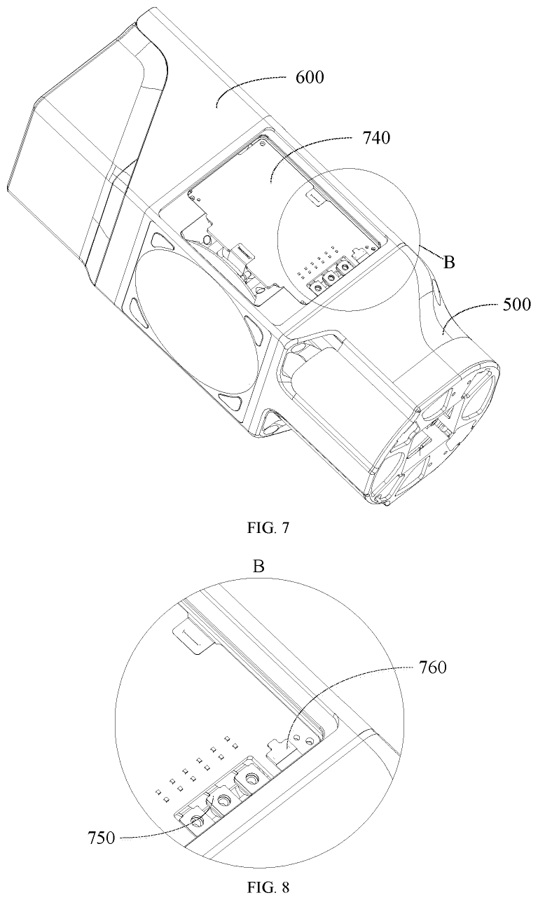

In some embodiments, referring to FIG. 1, FIG. 5, and FIG. 7, the motor 500 and the power supply assembly 600 are arranged on two opposite side surfaces of the cable housing 100.

In an embodiment, a weight of the motor 500 and a weight of the power supply assembly 600 (for example, the power supply assembly 600 may include the battery 610, etc.) are relatively large. By arranging the motor 500 and the power supply assembly 600 on the opposite sides of the cable housing 100, the weight thereof can be balanced, and a center of the output device is roughly located in the middle, which facilitates the user to hold the output device stably.

It should also be noted that when the user is accustomed to holding the output device with both hands, design of the embodiment can facilitate the user to hold the motor 500 and the power supply assembly 600 with both hands respectively, so that the user's hands bear weight evenly, which also improves the stability of holding the output device and reduces the possibility of the user accidentally dropping the output device when holding the output device.

In some embodiments, referring to FIG. 1 and FIG. 12, the output device may further include: a locking assembly, configured to lock the connecting structure 200; a first unlocking trigger apparatus or a first unlocking switch 511 (for example, a push switch), disposed on the motor 500 and communicatively connected to the locking assembly; and a second unlocking trigger apparatus or a second unlocking switch 6125 (for example, a push switch), disposed on the power supply assembly 600 and communicatively connected to the locking assembly. The locking assembly is configured to unlock the connecting structure 200 when both the first unlocking trigger apparatus 511 and the second unlocking trigger apparatus 6125 are triggered/actuated.

In the embodiment, by arranging the first unlocking trigger apparatus and the second unlocking trigger apparatus on the motor 500 and the power supply assembly 600 respectively, the connecting structure 200 can be unlocked when both the first unlocking trigger apparatus 511 and the second unlocking trigger apparatus 6125 are triggered. Thus, the user can be guided to hold the output device with both hands to detach the output device from the base 400, which may help reduce the possibility of accidental falling due to unstable holding when the output device is detached from the base 400, thereby improving user safety during use.

In some embodiments, referring to FIG. 10 to FIG. 12, the locking assembly may include: a locking member 300, movably disposed on the cable housing 100, and configured to abut against the connecting structure 200 to lock the connecting structure 200; and a driving apparatus, in transmission connection with the locking member 300, and connected to the first unlocking trigger apparatus 511 and the second unlocking trigger apparatus 6125. The driving apparatus is configured to drive the locking member 300 to move to unlock the connecting structure 200 when both the first unlocking trigger apparatus 511 and the second unlocking trigger apparatus 6125 are triggered.

In the embodiment, the locking member 300 is driven by the driving apparatus to be movable relative to the cable housing 100. For example, the locking member 300 may be slidably disposed on the cable housing 100, and an output shaft of the driving apparatus (for example, a motor) may be in driving connection with the locking member 300 via a gear-rack engagement. Thus, when the driving apparatus operates, the driving apparatus can drive the locking member 300 to slide relative to the cable housing 100.

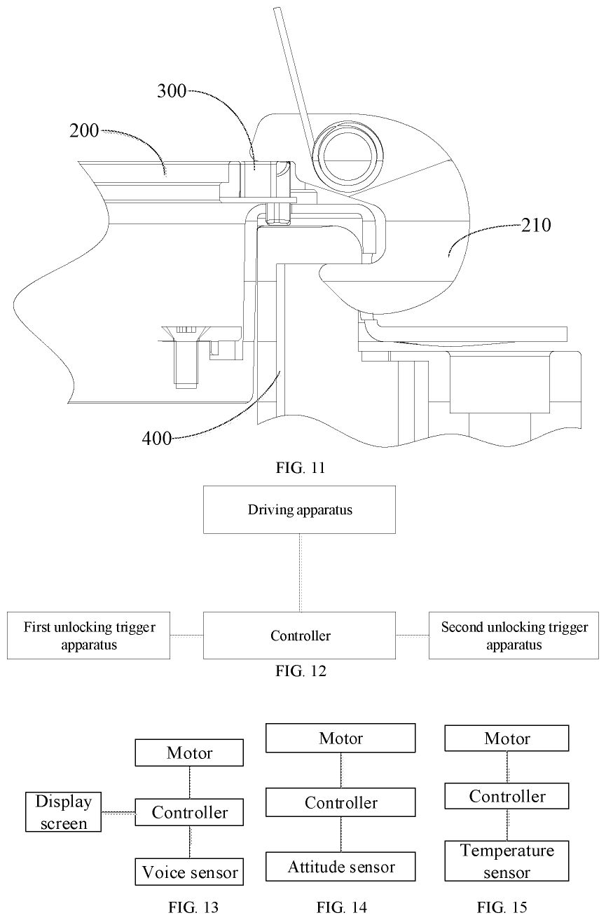

In some embodiments, referring to FIG. 10 and FIG. 11, the connecting structure 200 may include an engaging member 210 (for example, a hook) movably disposed on the cable housing 100. The engaging member 210 is engaged with the base 400 to fix the cable housing 100 to the base 400. When the engaging member 210 is engaged with the base 400, the locking member 300 can abut against the engaging member 210 to limit the movement of the engaging member 210. The driving apparatus is configured to drive the locking member 300 to move to release the abutment between the locking member 300 and the engaging member 210 when both the first unlocking trigger apparatus 511 and the second unlocking trigger apparatus 6125 are triggered.

In some embodiments, referring to FIG. 10 and FIG. 11, the engaging member 210 may be rotatably disposed on the cable housing 100. After the engaging member 210 is engaged with the base 400, the output device can be fixed on the base 400. Then, the locking member 300 can abut against the engaging member 210 to limit the engaging member 210 from rotating outward of the base 400 to disengage from the base 400, thereby locking the engaging member 210. When both the first unlocking trigger apparatus 511 and the second unlocking trigger apparatus 6125 are triggered, the driving apparatus can drive the locking member 300 to move, so that the locking member 300 and the engaging member 210 are released from abutment. The engaging member 210 can be rotated outward of the base 400 and disengage from the base 400, thus releasing the output device from the base 400.

Referring to FIGS. 20-22, in some embodiments, the winding reel 130 includes an inner core 131 and a winding reel housing or a reel shell 135. The winding reel housing 135 is partially or fully disposed around an outer side of the inner core 131. The winding reel housing 135 is configured to wind the cable 900. The thermal conductivity of the winding reel housing 135 is greater than the thermal conductivity of the inner core 131.

The winding reel housing 135 is disposed around the outer side of the inner core 131. Since the thermal conductivity of the winding reel housing 135 is greater than the thermal conductivity of the inner core 131, after the cable 900 is wound on the winding reel housing 135, the cable 900 can quickly conduct heat to dissipate heat, which may help reduce excessive heat generated by long-term friction between the cable 900 and the winding reel 130 from affecting operation of the output device.

In some embodiments, the inner core 131 may be a cylindrical structure, and a shaft hole may be defined through an axis of the inner core 131, and the spline 573 may be disposed in the shaft hole to be connected to the motor 500, so that the motor 500 can drive the winding reel 130 to rotate. A material of the inner core 131 may include plastic or hard rubber, etc., which not only has good structural strength, but also can effectively reduce overall weight of the winding reel 130.

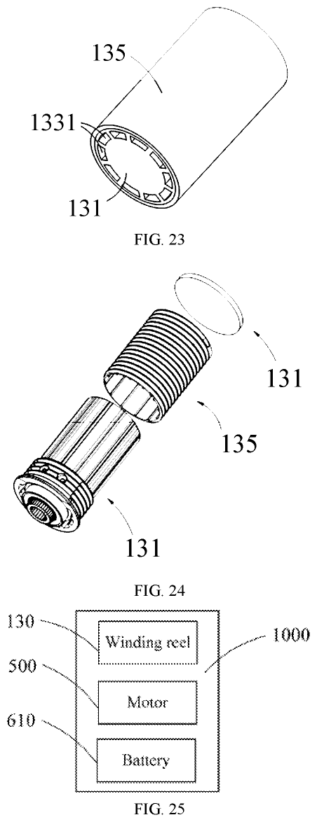

The winding reel housing 135 may be a hollow cylindrical structure, and a diameter of an inner peripheral wall of the winding reel housing 135 may match an outer diameter of the inner core 131, such that the winding reel housing 135 may be fittingly disposed around the outer side of the inner core 131. In some embodiments, as shown in FIG. 23, when the winding reel housing 135 is fully disposed around the outer side of the inner core 131, the cable 900 can be wound on the outer side of the winding reel housing 135, so that heat generated by friction between cables 900 or between the cable 900 and the winding reel housing 135 can be directly conducted to the winding reel housing 135.

In some embodiments, the winding reel housing 135 is partially disposed around the outer side of the inner core 131. Since the inner core 131 can be made of a material such as plastic or hard rubber, etc., it is convenient to process a structure for fixing the cable 900. At this time, an end portion of the cable 900 is fixed to the inner core 131. In some embodiments, the end portion of the cable 900 is fixed to the inner core 131, and a portion of the cable 900 close to the fixing end of the cable 900 is also wound on the inner core 131, and a remaining portion of the cable 900 is wound on the winding reel housing 135. Since when the cable 900 is pulled or retracted on the winding reel 130, a portion farther from or away from the fixing end of the cable 900 is more likely to be stretched frequently, thereby generating more heat. Thus, the winding reel housing 135 is configured to dissipate heat for the portion farther from the fixing end of the cable 900, so that heat from the portion of the cable 900 wound on the winding reel housing 135 can be timely conducted out through the winding reel housing 135.

In some embodiments, the winding reel housing 135 may be made of a metal material with high thermal conductivity such as copper or iron, etc., so that the winding reel housing 135 can better conduct the heat generated by the cable 900 during an extending-retracting process and a friction process. Therefore, the winding reel 130 can better dissipate heat.

Referring to FIGS. 20-22, in some embodiments, a first limiting structure 1322 is disposed on an outer peripheral side of the inner core 131. A second limiting structure 1351 corresponding to the first limiting structure 1322 is disposed on an inner peripheral side of the winding reel housing 135.

Thus, the winding reel housing 135 can be fixed and limited by cooperation of the second limiting structure 1351 with the first limiting structure 1322 on the inner core 131, so as to reduce a situation where the winding reel housing 135 shifts relative to the inner core 131 when the inner core 131 rotates. When the inner core 131 rotates, rotations of the winding reel housing 135 and the inner core 131 are relatively synchronized, such that connection and installation are more stable.

In some embodiments, the first limiting structure 1322 may be disposed on an outer peripheral wall of the inner core 131. The second limiting structure 1351 may be disposed on the inner peripheral wall of the winding reel housing 135. The first limiting structure 1322 and the second limiting structure 1351 are aligned with each other, so that the winding reel housing 135 can be stably connected and mounted with the inner core 131.

Referring to FIGS. 20-22, in some embodiments, both the first limiting structure 1322 and the second limiting structure 1351 extend along an axial direction of the winding reel 130.

Thus, the first limiting structure 1322 and the second limiting structure 1351 can better cooperate to limit the winding reel housing 135 and the inner core 131, which may help reduce the shifting of the winding reel housing 135 and the inner core 131 relative to each other when the winding reel 130 rotates.

In some embodiments, the first limiting structure 1322 may extend along an axial direction of the inner core 131. The second limiting structure 1351 corresponds to the first limiting structure 1322 and extends along an axial direction of the winding reel housing 135. When the winding reel 130 rotates, the inner core 131 is driven by the motor 500 to rotate around the axis of the inner core 131, and the first limiting structure 1322 and the second limiting structure 1351 extend axially, so that a force direction between the inner core 131 and the winding reel housing 135 is substantially perpendicular to a rotation direction of the winding reel 130, thereby achieving a better limiting effect. At the same time, when the inner core 131 is assembled with the winding reel housing 135, the inner core 131 and the winding reel housing 135 can be sleeved peripherally, so that the first limiting structure 1322 and the second limiting structure 1351 are engaged with each other peripherally.

Of course, in some other embodiments, the first limiting structure 1322 and the second limiting structure 1351 may also be arranged around a peripheral direction of the inner core 131 and the winding reel housing 135 at a certain angle, or be arranged in other forms, which is not specifically limited herein.

Referring to FIGS. 20-22, in some embodiments, the first limiting structure 1322 includes a first connecting rib 1323. The first connecting rib 1323 extends along the axial direction of the inner core 131 and protrudes from an outer peripheral surface of the inner core 131. A second limiting groove 1324 is defined on the first connecting rib 1323.

The second limiting structure 1351 includes a second limiting protrusion 1352. The second limiting protrusion 1352 extends along an axial direction of the winding reel housing 135 and protrudes from an inner peripheral surface of the winding reel housing 135. The second limiting protrusion 1352 is engaged with the second limiting groove 1324.

Thus, the inner core 131 can be limited by cooperation of the first connecting rib 1323 with the second limiting protrusion 1352 on the winding reel housing 135, and the second limiting protrusion 1352 is engaged with the second limiting groove 1324 on the first connecting rib 1323. At the same time, a gap is defined between the winding reel housing 135 and the inner core 131 driven by the first connecting rib 1323 and the second limiting protrusion 1352, thereby effectively improving heat dissipation efficiency of the winding reel housing 135.

In some embodiments, the first connecting rib 1323 may be protruded on the outer peripheral wall of the inner core 131 and be in a continuous long strip structure, and extend along the axial direction of the inner core 131. In some other embodiments, the first connecting rib 1323 may also be in an intermittent strip structure or a block structure, etc., which is not limited herein. The second limiting groove 1324 is defined on a side of the first connecting rib 1323 facing the winding reel housing 135. A shape of the second limiting groove 1324 may match a shape of the second limiting protrusion 1352. The second limiting protrusion 1352 may generally also be in a continuous long strip structure. When the winding reel housing 135 is disposed around the inner core 131, the second limiting protrusion 1352 can be engaged with the second limiting groove 1324.

Since the first connecting rib 1323 is protruded on the outer peripheral wall of the inner core 131, after the winding reel housing 135 is mounted, there will be a certain gap between the winding reel housing 135 and the inner core 131, and a heat dissipation channel 133 may be defined. After the cable 900 is wound on the winding reel housing 135, the heat dissipation channel 133 can accelerate the heat dissipation effect of the winding reel housing 135.

Referring to FIGS. 20-22, in some embodiments, there are a plurality of first connecting ribs 1323 and a plurality of the second limiting protrusions 1352. The plurality of first connecting ribs 1323 are arranged at intervals around a peripheral direction of the nesting portion 1321. The plurality of second limiting protrusions 1352 are arranged at intervals around an inner periphery of the winding reel housing 135. The plurality of first connecting ribs 1323 are in one-to-one correspondence with the plurality of second limiting protrusions 1352.

Thus, the plurality of first connecting ribs 1323 and the plurality of second limiting protrusions 1352 can better support the winding reel housing 135, and a contact area between the winding reel housing 135 and the inner core 131 is larger, resulting in a better heat dissipation effect for the cable 900 on the winding reel housing 135.

In some embodiments, the plurality of first connecting ribs 1323 may be evenly arranged at intervals around the peripheral direction of the inner core 131. Correspondingly, the plurality of second limiting protrusions 1352 may be evenly arranged at intervals around the inner periphery of the winding reel housing 135. The number of the first connecting ribs 1323 corresponds to the number of the second limiting protrusions 1352, and the number of the first connecting ribs 1323 and the second limiting protrusions 1352 is not limited herein.

Of course, in some other embodiments, the first limiting structure 1322 and the second limiting structure 1351 may also be connected and mounted in other forms. For example, the second limiting groove 1324 is directly defined on the outer peripheral wall of the inner core 131 to be mounted corresponding to the second limiting protrusion 1352 on the winding reel housing 135, etc. The present disclosure does not limit specific structures of the first limiting structure 1322 and the second limiting structure 1351.

Referring to FIGS. 20-23, in some embodiments, a plurality of heat dissipation channels 133 communicating from an end portion to the outside are defined on the outer side of the inner core 131. The plurality of heat dissipation channels 133 are located on an inner side of the winding reel housing 135 and can timely transfer heat from the inner side of the winding reel housing 135 to the outside. In some embodiments, the heat dissipation channel 133 is arranged axially, which is more convenient for heat dissipation in the channel, which may help support the heat dissipation effect, and improve structural stability. In some embodiments, the heat dissipation channel 133 is arranged along a spiral. Through rotation of the winding reel, the heat dissipation channel 133, which is spirally arranged, can drive internal gas/air to generate airflow, thereby actively dissipating heat, and further enhancing the heat dissipation effect. There may be a plurality of heat dissipation channels 133. The multiple heat dissipation channels 133 are arranged at intervals in a peripheral direction of the outer side of the inner core 131.

In some embodiments, the heat dissipation channel 133 may be a heat dissipation hole 1331. The heat dissipation hole 1331 is defined inside the inner core 131 and in communication with both ends of the inner core 131 adjacent to the outer side. The heat dissipation channel 133 may be a heat dissipation groove 1332. The heat dissipation groove 1332 is defined at the outer side of the inner core 131 and in communication with both ends of the inner core 131. The heat dissipation groove 1332 and the winding reel housing 135 disposed around the outer side of the heat dissipation groove 1332 together enclose to form the heat dissipation channel 133. The heat dissipation channel 133 may be as shown in FIG. 22, the heat dissipation channels 133 formed by the two ways can coexist, at this time, the heat dissipation hole 1331 is located on an inner side of the heat dissipation groove 1332.

Referring to FIGS. 20-22, in some embodiments, the inner core 131 is axially divided into a fixing portion 1311 and a nesting portion 1321 connected to the fixing portion 1311. The fixing portion 1311 is configured to fix the cable 900. The winding reel housing 135 is disposed around the nesting portion 1321. Thus, an end of the cable 900 can be fixed on the fixing portion 1311 and then wound on the winding reel housing 135.

In some embodiments, the fixing portion 1311 may be disposed at an end of the inner core 131. A cable fixing structure may be disposed on the fixing portion 1311. The end of the cable 900 may be fixedly connected to the fixing portion 1311, and then wound from a fixing end of the cable 900 toward the nesting portion 1321. The nesting portion 1321 is connected to other side of the fixing portion 1311 and is coaxially arranged with the fixing portion 1311. The first limiting structure 1322 may be disposed on an outer peripheral wall of the nesting portion 1321. A length of the winding reel housing 135 may match a length of the nesting portion 1321. The winding reel housing 135 is disposed around an outer side of the nesting portion 1321.

Referring to FIGS. 20-22, in some embodiments, a first winding groove 1312 is defined on an outer peripheral surface of the fixing portion 1311. A second winding groove 1353 is defined on an outer peripheral surface of the winding reel housing 135. When the winding reel housing 135 is disposed around the nesting portion 1321, the outer peripheral surface of the winding reel housing 135 is aligned with the outer peripheral surface of the fixing portion 1311, and an end portion of the first winding groove 1312 close to the nesting portion 1321 is connected to an end portion of the second winding groove 1353.

Thus, when the winding reel housing 135 is mounted on the nesting portion 1321, the outer peripheral surface of the winding reel housing 135 and the outer peripheral surface of the fixing portion 1311 can be flush with each other to form an integral surface, so that the cable 900 can be wound more neatly on an outer peripheral surface of the winding reel 130. Meanwhile, the first winding groove 1312 and the second winding groove 1353 can play a role in facilitating winding the cable to a certain extent, which may further improve flatness of the cable 900 wound outside the winding reel 130, such that it may effectively reduce the knotting or pressing of the cable 900 when winding the cable 900.

In some embodiments, an outer diameter of the fixing portion 1311 may be larger than an outer diameter of the nesting portion 1321. After the winding reel housing 135 is disposed around the nesting portion 1321, the outer peripheral surface of the winding reel housing 135 can be flush with the outer peripheral surface of the fixing portion 1311, which is beneficial for winding the cable 900 on the winding reel 130. A first winding groove 1312 may be defined on the outer peripheral surface of the fixing portion 1311. The first winding groove 1312 is continuously disposed around a peripheral direction of the fixing portion 1311 and extends toward the nesting portion 1321. A second winding groove 1353 may be defined on the outer peripheral surface of the winding reel housing 135. A starting end of the second winding groove 1353 close to the fixing portion 1311 is connected to a tail end of the first winding groove 1312.

A width of the first winding groove 1312 and a width of the second winding groove 1353 may be set according to a thickness/diameter of the cable 900, and the width of the first winding groove 1312 and the width of the second winding groove 1353 are not limited herein.

After the cable 900 is fixed on the fixing portion 1311, the cable 900 can be first wound along the first winding groove 1312 and then wound along the second winding groove 1353. Therefore, the arrangement of the cable 900 on the winding reel 130 will be more flat and regular, which may help reduce the overlapping and winding together of multiple turns of the cable 900, and reduce an adverse effect on winding and releasing/unwinding the cable 900.

Referring to FIGS. 20-22, in some embodiments, the inner core 131 is formed by injection molding. When the inner core 131 is injection molded, the winding reel housing 135 is placed in a mold to be integrally formed with the inner core 131.

Thus, manufacturing process in which the inner core 131 and the winding reel housing 135 are directly integrally injection-molded through the mold is relatively convenient and efficient, and connection and installation between the winding reel housing 135 and the inner core 131 are also more stable.

In some embodiments, during a manufacturing process of the winding reel 130, the inner core 131 may be injection-molded first, and then the winding reel housing 135 may be directly injection-molded on the outside of the inner core 131 via the mold, and overall injection molding method is relatively efficient and convenient, which may improve manufacturing efficiency of the winding reel 130. The first winding groove 1312 and the second winding groove 1353 can be continuously defined on the outer peripheral wall of the whole after integral injection molding, which may ensure continuity between the first winding groove 1312 and the second winding groove 1353.

Referring to FIGS. 20-22, in some embodiments, flanges 134 are disposed peripherally on both ends of the inner core 131 outward. The flanges protrude in a direction away from the axis of the inner core 131.

Thus, the flanges on both sides of the inner core 131 can effectively reduce the occurrence of the cable 900 slipping off the winding reel 130 when the cable 900 is wound to an end portion of the inner core 131, which may improve the stability of the cable 900 when winding the cable 900.

In some embodiments, the flange may be formed as a sheet-like structure protruding around the end portion of the inner core 131 in a direction away from the axis of the inner core 131. Therefore, when the cable 900 is wound to both ends of the winding reel 130, the flange can prevent the cable 900 from slipping, which may enable the cable 900 to be better wound on the winding reel 130. A specific protruding height of the flange may be determined according to the thickness of the cable 900 and a winding height of the cable 900 on the winding reel 130, which is not limited herein.

In some embodiments, the inner core 131 is formed as a split manner, and the winding reel housing 135 is detachably disposed around the outer side of the inner core 131. Thus, the winding reel housing 135 can be detached and replaced from the inner core 131, which may facilitate maintenance and replacement when the winding reel housing 135 is damaged.

In some embodiments, as shown in FIG. 24, the inner core 131 may be configured as a split structure, that is, two split parts of the inner core 131 can be connected and detached by means of screwing or engaging, etc. When the winding reel housing 135 needs to be replaced or detached, the two split parts of the inner core 131 can be separated, and then the winding reel housing 135 can be directly removed from the nesting portion 1321. In the embodiment, when mounting the winding reel housing 135, attention should be paid to the coupling between the second winding groove 1353 on the winding reel housing 135 and the first winding groove 1312 on the fixing portion 1311.

In some embodiments, the first winding groove 1312 can be aligned with the second winding groove 1353 through cooperation of the first limiting structure 1322 and the second limiting structure 1351. In some embodiments, the winding reel housing 135 may be first mounted on the nesting portion 1321, and then the first winding groove 1312 and the second winding groove 1353 may be respectively processed/defined on the fixing portion 1311 and the winding reel housing 135, so that the coupling between the first winding groove 1312 and the second winding groove 1353 will be more accurate, which may facilitate the winding of the cable 900.

As shown in FIGS. 19-20, an output device according to some embodiments of the present disclosure includes a casing 1000, a motor 500, a battery 610, and a winding reel 130. The battery 610 is electrically connected to the motor 500 and is configured to supply power to the motor 500. The winding reel 130 is rotatably mounted in the casing 1000, and the motor 500 is connected to the winding reel 130 to drive the winding reel 130 to rotate. A cable 900 is wound around the winding reel 130. The output device can drive the winding reel 130 via the motor 500 to wind or release the cable 900 relative to the winding reel 130, such that it may be possible to provide power or resistance to outside, which may achieve a good fitness effect.

The casing 1000 may be configured to support and fix a plurality of components on the output device. The casing 1000 may have a rectangular shape and may be hollow inside. The winding reel 130 is rotatably mounted in the casing 1000. The cable 900 is wound around the winding reel 130. The cable 900 can extend and retract freely relative to the casing 1000. The motor 500 and the battery 610 are detachably mounted on the casing 1000.

In some embodiments, the motor 500 and the battery 610 may be disposed at two sides of the casing 1000, which may make the overall output device more balanced, which may facilitate the installation and operation of the output device. Of course, some embodiments of the present disclosure do not limit a mounting position of the motor 500 and the battery 610 relative to the casing 1000, as long as the motor 500 is drivingly connected to the winding reel 130 to drive the winding reel 130 to rotate, and the battery 610 is electrically connected to the motor 500 to provide power to the motor 500. The motor 500 may include a servo motor, or the like. The battery 610 may include a lithium battery, or the like. A type of the motor 500 and a type of the battery 610 are not limited herein.

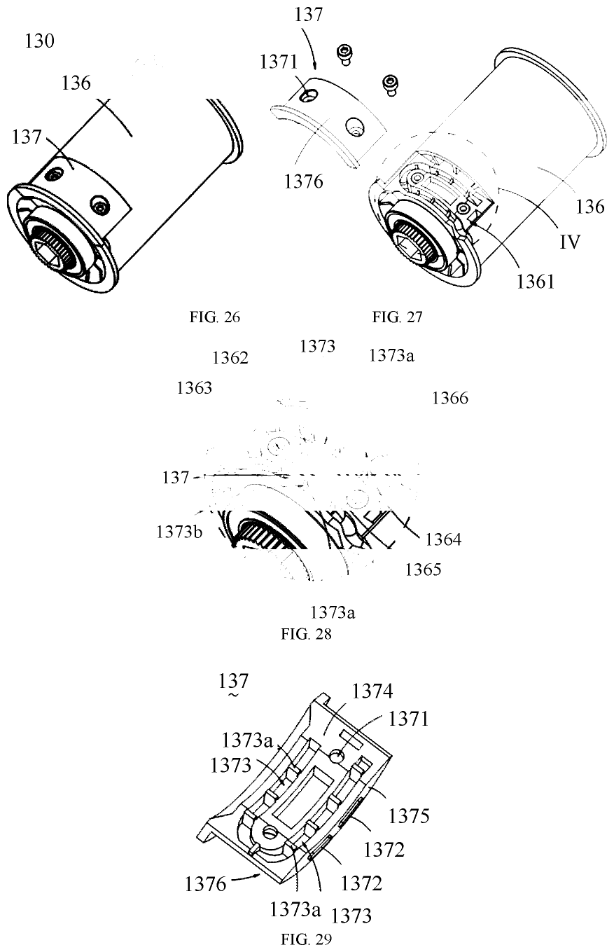

Referring to FIG. 26 and FIG. 27, the winding reel 130 according to an embodiment of the present disclosure includes a reel body 136 and a cable-pressing member 137. The reel body 136 is configured to wind the cable, and a fixing position 1361 is arranged on a side surface of the reel body 136. The cable-pressing member 137 is mounted at the fixing position 1361, and the cable-pressing member 137 and the fixing position 1361 are configured to press and fix the cable 900.

In some embodiments, the reel body 136 may be the inner core 131.

In the winding reel 130 according to an embodiment of the present disclosure, the cable 900 is pressed and fixed by the cable-pressing member 137 and the fixing position 1361 on the reel body 136, which may stably fix the cable 900 on the winding reel 130, which may help reduce the loosening of the cable 900. In addition, it may enable the end of the cable 900 to be hidden and fixed in the fixing position 1361, which may reduce the possibility of a fixing part of the cable 900 interfering with rotation of the winding reel 130.

In some embodiments, the reel body 136 may be in a cylindrical structure to facilitate the rotation of the winding reel 130, which may enable the cable 900 to be better wound on the outer peripheral wall of the winding reel 130. The reel body 136 may be injection-molded from the material such as the plastic or the hard rubber, etc., which not only has the relatively simple manufacturing process and is easy to manufacture, but also has the good structural strength and is not easily damaged. The present disclosure does not limit the material and forming method of the reel body 136.

The fixing position 1361 may be provided on the outer peripheral wall of the reel body 136, and the cable-pressing member 137 is mounted in cooperation with the fixing position 1361 to press an end of the cable 900. In this way, the end of the cable 900 is more firmly fixed under the pressing of the cable-pressing member 137 and the fixing position 1361, thereby preventing the cable 900 from loosening during the winding process of the winding reel 130. At the same time, a cooperation mode between the cable-pressing member 137 and the fixing position 1361 also enables the fixing of the cable 900 to be more convenient and efficient.

Further, the fixing position 1361 may be configured in a groove shape, and is recessed from the outer peripheral wall of the reel body 136 toward an axis of the reel body 136. The shape of the cable-pressing member 137 may match a recessed shape of the fixing position 1361, that is, the cable-pressing member 137 may be tightly buckled/pressed in the fixing position 1361, which can reduce an effect on the rotation of the reel body 136 and the winding of the cable 900 on the reel body 136.

When mounting the cable 900, the end of the cable 900 may be placed in the fixing position 1361, and then the cable-pressing member 137 is buckled at the fixing position 1361, so that the cable 900 can be firmly pressed between the cable-pressing member 137 and the fixing position 1361, which may ensure more stable fixing of the cable 900. At the same time, the fixing end of the cable 900 can be also hidden between the cable-pressing member 137 and the fixing position 1361, which may help reduce the possibility of the fixing end of the cable 900 knotting with the cable 900 during a subsequent winding process and may help reduce an effect on the rotation of the winding reel 130.

Referring to FIGS. 27-29, in some embodiments, the fixing position 1361 is located at an end portion of a peripheral wall of the reel body 136. The cable-pressing member 137 is aligned with the fixing position 1361.

Thus, the cable 900 can be arranged from one end of the winding reel 130 to the other end of the winding reel 130 during winding the cable 900, so that the cable 900 is arranged more evenly on the winding reel 130, which may help reduce cable entanglement/tangling when winding or releasing the cable 900.

In some embodiments, the fixing position 1361 may be arranged at an end portion of the outer peripheral wall of the reel body 136, and thus the end of the cable 900 will be fixed at a side of an end portion of the reel body 136. When winding the cable 900, the cable 900 can be wound from the one end of the fixing position 1361 of the reel body 136 to the other end of the fixing position 1361, and the cable 900 can be evenly and tightly arranged/wound on the winding reel 130.

In an embodiment of the present disclosure, a length of the cable 900 may be set to a length of one layer arranged from one end of the reel body 136 to the other end of the reel body 136, so that the cable 900 is not easy to be knotted or entangled/tangled when arranged. Of course, when the cable 900 is relatively long, the cable 900 may also be arranged from one end of the reel body 136 to the other end of the reel body 136 in one layer, and then wound in a second layer returning from the other end to the one end. Since the cable 900 is wound relatively tightly in a first layer, it may be possible to reduce entanglement or knotting between the second layer and the first layer when the second layer is wound.

In other embodiments, the fixing position 1361 may be located at any position on the outer peripheral wall of the reel body 136, and a position where the fixing position 1361 on the reel body 136 is disposed is not limited herein.

Referring to FIGS. 27-29, in some embodiments, a second cable groove 1373 is defined at the fixing position 1361 and/or the cable-pressing member 137. The second cable groove 1373 is configured to accommodate the cable 900. The cable-pressing member 137 and/or the fixing position 1361 may be configured to press the cable 900 in the second cable groove 1373.

Thus, the end of the cable 900 can be placed in the second cable groove 1373 and then pressed by the cable-pressing member 137, making installation of the cable 900 more convenient and preventing the end of the cable 900 from shifting randomly during pressing.

In some embodiments, the second cable groove 1373 may be defined at the fixing position 1361, or may be defined on the cable-pressing member 137, or may be provided on both the fixing position 1361 and the cable-pressing member 137. A depth of the second cable groove 1373 may be set according to a diameter of the cable 900. When each of the fixing position 1361 and the cable-pressing member 137 defines the second cable groove 1373, a height of a cross-section enclosed by two second cable grooves 1373 may be set according to the diameter of the cable 900. When fixing the cable 900, the end of the cable 900 can be first placed in the second cable groove 1373, and then the cable-pressing member 137 is mounted at the fixing position 1361, so that the end of the cable 900 can be accurately pressed between the cable-pressing member 137 and the fixing position 1361 under the limitation of the second cable groove 1373, which may help reduce the possibility of the end of the cable 900 shifting randomly and not being pressed during pressing.

In some embodiments, the second cable groove 1373 is curved. Thus, the resistance to pulling the cable 900 in a cable groove is improved, and the curved second cable groove 1373 can provide a greater fixing force to the cable 900 at a curved position. After the cable-pressing member 137 presses the cable 900, the cable 900 can be more stable and more firmly fixed in the second cable groove 1373. For example, the second cable groove 1373 may be in an arc shape, a ring shape, a S shape, etc. The present disclosure does not limit this.

Referring to FIGS. 27-29, in some embodiments, the fixing position 1361 includes a second mounting position 1362, and when the cable-pressing member 137 is mounted on the reel body 136, the second cable groove 1373 is defined around a peripheral side of the second mounting position 1362.

Thus, the cable-pressing member 137 can be mounted in cooperation with the second mounting position 1362 at the fixing position 1361. The second cable groove 1373 is defined around the peripheral side of the second mounting position 1362, such that it can not only be curved to enhance fixing the stability of the cable 900, but also reduce an opening area of the fixing position 1361 on the reel body 136, making installation more convenient. In addition, when the second cable groove 1373 is defined around the peripheral side of the second mounting position 1362, and the cable-pressing member 137 is fixed through the second mounting position 1362, pressure provided by the second mounting position 1362 can better act on the second cable groove 1373, so as to press the cable through the second cable groove 1373.

In some embodiments, the second mounting position 1362 may be located in a middle position inside a groove of the fixing position 1361, and correspondingly, a middle part of the cable-pressing member 137 may have a structure matching with the second mounting position 1362, so that the cable-pressing member 137 can be mounted and fixed with the second mounting position 1362. The second cable groove 1373 can be arranged around the second mounting position 1362, which not only increases a length of the end of the cable 900 in the second cable groove 1373, but also can increase the friction force of the cable 900 in the second cable groove 1373 by curving and placing the cable 900 in the second cable groove 1373. Furthermore, the second mounting position 1362 can provide better pressing force for the second cable groove 1373, so that the cable 900 can be mounted more firmly and stably.

Referring to FIGS. 27-29, in some embodiments, a second mounting position 1362 is provided on the fixing position 1361. A screw hole 1363 is defined on the second mounting position 1362. A first through hole 1371 corresponding to the screw hole 1363 is defined on the cable-pressing member 137. The cable-pressing member 137 is fixed at the fixing position 1361 by passing a screw through the first through hole 1371 and screwing the screw into the screw hole 1363.

Thus, the cable-pressing member 137 can press the cable 900 by cooperating with the screw hole 1363 on the mounting position, which has a strong fixing effect. Therefore, it is convenient for installation and disassembly, which facilitates replacement of the cable 900.

In some embodiments, the second mounting position 1362 may be formed in a middle position inside a groove of the fixing position 1361 and may be in a boss-like structure. At least one screw hole 1363 is defined on the second mounting position 1362, and the number and the position of the screw hole 1363 may be selected according to size of the second mounting position 1362. A shape of the second mounting position 1362 and the number and the position of the screw hole 1363 defined on the second mounting position 1362 are not limited herein.

Correspondingly, the first through hole 1371 may be defined on the cable-pressing member 137, and a position and the number of the first through hole 1371 may be corresponding to the position and the number of the screw hole 1363. A screw passes through the first through hole 1371 and is screwed into the screw hole 1363 to fix the cable-pressing member 137 at the fixing position 1361, thereby pressing the cable 900 between the cable-pressing member 137 and the fixing position 1361, which has a good fixing effect on the cable 900, and is convenient for installation and disassembly of the cable-pressing member 137.

Referring to FIGS. 27-29, in some embodiments, a plurality of cable-pressing protrusions 1373a are provided on the fixing position 1361 and/or the cable-pressing member 137. The plurality of cable-pressing protrusions 1373a are arranged at intervals along an extending direction of the second cable groove 1373.

Thus, when the cable-pressing member 137 is mounted at the fixing position 1361, the plurality of cable-pressing protrusions 1373a can further press the cable 900, which may improve the stability of the cable 900 in the second cable groove 1373, enhancing fixing strength of the cable 900, and preventing the cable 900 from loosening.

In some embodiments, the plurality of cable-pressing protrusions 1373a may be provided on the fixing position 1361, or arranged on the cable-pressing member 137, or arranged on both the fixing position 1361 and the cable-pressing member 137. When the plurality of cable-pressing protrusions 1373a are arranged at the fixing position 1361, if the second cable groove 1373 is defined at the fixing position 1361, the plurality of cable-pressing protrusions 1373a may be formed in the second cable groove 1373 at the fixing position 1361. If no second cable groove 1373 is defined at the fixing position 1361, the plurality of cable-pressing protrusions 1373a may be arranged at a position corresponding to the second cable groove 1373 on the cable-pressing member 137, and the plurality of cable-pressing protrusions 1373a are arranged at intervals along the extending direction of the second cable groove 1373. When the plurality of cable-pressing protrusions 1373a are provided on the cable-pressing member 137, if the second cable groove 1373 is provided on the cable-pressing member 137, the plurality of cable-pressing protrusions 1373a may be provided in the second cable groove 1373; if no second cable groove 1373 is provided on the cable-pressing member 137, the plurality of cable-pressing protrusions 1373a may be formed at a position corresponding to the second cable groove 1373 on the cable-pressing member 137, and the plurality of cable-pressing protrusions 1373a are also arranged at intervals along the extending direction of the second cable groove 1373. Thus, when the cable-pressing member 137 is pressed tightly, the plurality of cable-pressing protrusions 1373a can better clamp the cable 900, which may help reduce the possibility of the cable 900 slipping off.

In some embodiments, when the plurality of cable-pressing protrusions 1373a are provided on both the fixing position 1361 and the cable-pressing member 137, the plurality of cable-pressing protrusions 1373a on the fixing position 1361 and the plurality of cable-pressing protrusions 1373a on the cable-pressing member 137 are arranged in a staggered manner, which may help reduce the possibility of the cable 900 being damaged due to excessive snapping by the plurality of cable-pressing protrusions 1373a. Therefore, it may help reduce interference with installation of the cable-pressing member 137 at the fixing position 1361 caused by alignment of the cable-pressing protrusion 1373a on the cable-pressing member 137 and the cable-pressing protrusion 1373a on the fixing position 1361. At the same time, a staggered arrangement of the plurality of cable-pressing protrusions 1373a above and below the cable 900 increases snapping/engaging points for the cable 900, which may further improve fixing effect of the cable 900.

Referring to FIGS. 27-29, in some embodiments, a corresponding one of the plurality of cable-pressing protrusions 1373a is a sheet-like structure, and a protruding direction of the corresponding one of the plurality of cable-pressing protrusions 1373a is substantially perpendicular to the extending direction of the second cable groove 1373. Thus, a contact point between the sheet-like cable-pressing protrusion 1373a and the cable 900 is smaller, which can generate greater pressure on the cable 900, which may improve the snapping effect of the corresponding one of the plurality of cable-pressing protrusions 1373a on the cable 900. A vertical arrangement can better press the cable 900 in the second cable groove 1373.

In some embodiments, an arc-shaped notch 1373b is defined at a contact end of the corresponding one of the plurality of cable-pressing protrusions 1373a that contacts the cable 900. Thus, when the corresponding one of the plurality of cable-pressing protrusions 1373a is pressed and contacted with the cable 900, the arc-shaped notch 1373b can reduce the possibility of the cable 900 being damaged after the cable 900 is pressed, and may be configured to protect the cable 900 when fixing and pressing the cable 900.

In some embodiments, a shape of the arc-shaped notch 1373b may match a thickness/diameter of the cable 900. The arc-shaped notch 1373b of the corresponding one of the plurality of cable-pressing protrusions 1373a on the fixing position 1361 may be defined at an end portion facing the cable-pressing member 137. The arc-shaped notch 1373b of the corresponding one of the plurality of cable-pressing protrusions 1373a on the cable-pressing member 137 may be defined at an end portion facing the fixing position 1361.

In some embodiments, the arc-shaped notch 1373b may be only defined on the corresponding one of the plurality of cable-pressing protrusions 1373a on the fixing position 1361, or only defined on the corresponding one of the plurality of cable-pressing protrusions 1373a on the cable-pressing member 137, so that the corresponding one of the plurality of cable-pressing protrusions 1373a has a better snapping effect on the cable 900. Of course, the arc-shaped notches 1373b may also be defined on the corresponding one of the plurality of cable-pressing protrusions 1373a on the fixing position 1361 and defined on the corresponding one of the plurality of cable-pressing protrusions 1373a on the cable-pressing member 137, which is not limited herein.

Referring to FIGS. 27-29, in some embodiments, a first positioning protrusion 1372 is arranged on one of the fixing position 1361 and the cable-pressing member 137, and a first positioning groove 1364 is defined on the other of the fixing position 1361 and the cable-pressing member 137. The first positioning protrusion 1372 and the first positioning groove 1364 correspond to each other.

Thus, when mounting the cable-pressing member 137, the cable-pressing member 137 can be positioned via the first positioning protrusion 1372 and the first positioning groove 1364, which may enable accurate alignment of the cable-pressing member 137 and make installation more convenient and efficient.

In some embodiments, when the first positioning protrusion 1372 is provided on the fixing position 1361, the first positioning groove 1364 is defined on the cable-pressing member 137. When the first positioning groove 1364 is defined at the fixing position 1361, the first positioning protrusion 1372 is provided on the cable-pressing member 137. The number of the first positioning protrusions 1372 may be at least one, and the number and the position of the first positioning grooves 1364 correspond to those of the first positioning protrusions 1372.

When installing the cable-pressing member 137, the first positioning protrusion 1372 can be aligned with the first positioning groove 1364 first, and then a bolt is tightened to fix. Thus, the first through hole 1371 on the cable-pressing member 137 and the screw hole 1363 on the fixing position 1361 are also aligned one by one, which may facilitate the bolt to pass through and tighten to fix the cable-pressing member 137.

Referring to FIGS. 27-29, in some embodiments, the fixing position 1361 includes a first connecting surface 1365 and a first side surface 1366 located on a side of the first connecting surface 1365. The first connecting surface 1365 is configured to press the cable 900.

The cable-pressing member 137 includes a second connecting surface 1374 opposite to the first connecting surface 1365, and a second side surface 1375 opposite to the first side surface 1366. The first positioning protrusion 1372 and the first positioning groove 1364 are respectively located on the first side surface 1366 and the second side surface 1375.

Thus, the first positioning protrusion 1372 and the first positioning groove 1364 are respectively located on the side surfaces of the fixing position 1361 and the cable-pressing member 137, such that it can not only play a positioning role in installation and fixing of the cable-pressing member 137, but also play an auxiliary role in pressing the cable to a certain extent.

In some embodiments, the first connecting surface 1365 may be a surface on the fixing position 1361 that corresponds to the cable-pressing member 137 and configured to press the cable 900. The second cable groove 1373 and the second mounting position 1362 may be located on the first connecting surface 1365. The first side surface 1366 may be connected to the first connecting surface 1365 and form a certain angle with the first connecting surface 1365. The second connecting surface 1374 may be a surface on the cable-pressing member 137 that cooperates with the first connecting surface 1365 to press the cable 900. The second cable groove 1373 may also be defined on the second connecting surface 1374. The second side surface 1375 is connected to the second connecting surface 1374 and is opposite to the first side surface 1366 when the cable-pressing member 137 is mounted.

The first positioning protrusion 1372 and the first positioning groove 1364 may be respectively arranged on the first side surface 1366 and the second side surface 1375. That is, the first positioning protrusion 1372 may be arranged on the first side surface 1366, and the first positioning groove 1364 may be defined on the second side surface 1375; or the first positioning protrusion 1372 may be arranged on the second side surface 1375, and the first positioning groove 1364 is defined on the first side surface 1366, which is not limited herein.

When mounting the cable-pressing member 137, the first positioning protrusion 1372 and the first positioning groove 1364 can be aligned first, so that the second side surface 1375 of the cable-pressing member 137 is aligned with the first side surface 1366. Then, a position where the first positioning protrusion 1372 is engaged with the first positioning groove 1364 is configured as a fulcrum and a positioning point, and a bolt is tightened to press the cable-pressing member 137, which may help support installation accuracy of the cable-pressing member 137 and provide a better fixing effect for the cable 900.

Referring to FIGS. 27-29, in some embodiments, the cable-pressing member 137 includes a winding surface 1376. The winding surface 1376 is an arcuate surface and is tangent to an outer peripheral surface of the reel body 136.

Thus, when the cable-pressing member 137 is mounted at the fixing position 1361, the winding surface 1376 of the cable-pressing member 137 can be aligned with the outer peripheral surface of the reel body 136, so that the cable-pressing member 137 can press the cable 900 without affecting the winding of the cable 900 on the reel body 136.

In some embodiments, the winding surface 1376 is a surface of the cable-pressing member 137 opposite to the first connecting surface 1365. When the cable-pressing member 137 is mounted at the fixing position 1361, an edge of the winding surface 1376 is connected to an edge of the reel body 136 and is tangent to the peripheral surface of the reel body 136. That is, after the cable-pressing member 137 is mounted at the fixing position 1361 to press the cable 900, the winding surface 1376 will not protrude or be recessed relative to the outer peripheral surface of the reel body 136. Therefore, when the cable 900 is wound on the reel body 136, the cable-pressing member 137 will not affect the winding of the cable 900, so that the cable 900 can be wound more neatly.

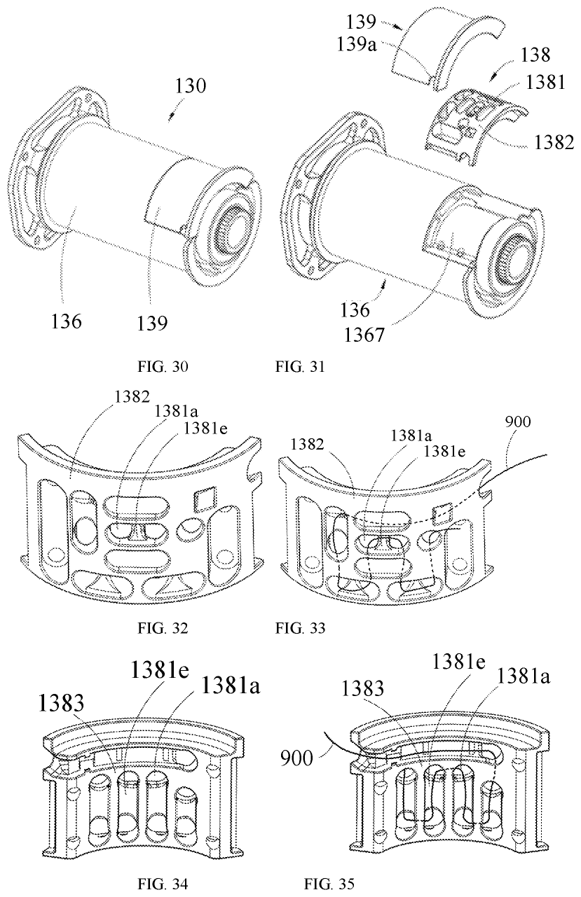

Referring to FIG. 30 and FIG. 31, in some embodiments, the winding reel 130 includes: a winding disc 138, including a plurality of winding positions 1381 or a plurality of positions of winding the cable 900, where the plurality of winding positions 1381 are configured to wind an end of the cable 900, so that the end of the cable 900 is fixed to the winding disc 138; a reel body 136, where the winding disc 138 is mounted on the reel body 136, and the reel body 136 is configured to wind a remaining portion of the cable 900.

A winding apparatus in embodiments of the present disclosure includes the winding disc 138 and the reel body 136. In some embodiments, the winding disc 138 may be the cable-pressing member 137.

The winding disc 138 includes the plurality of winding positions 1381 configured to wind an end of the cable 900, so that the end of the cable 900 can be fixed to the winding disc 138, and then the remaining portion of the cable 900 is wound on the reel body 136. In some embodiments, during winding, the cable 900 can be regularly arranged around an axial direction of the reel body 136, so that the reel body 136 can rotate smoothly when the cable 900 is pulled out or retracted. Thus, by arranging the winding positions 1381, it may enable the end of the cable 900 to be fully wound and fixed on the winding disc 138, which may strengthen the connection between the cable 900 and the winding disc 138, thereby improving the stability of the connection between the cable 900 and the winding disc 138, and enhancing the safety performance of the winding apparatus.

It should be noted that the winding positions 1381 in embodiments of the present disclosure can enable the cable 900 to turn multiple times when the cable 900 passes through the plurality of winding positions 1381, and a turning angle is no less than 90 degrees, so that the cable 900 can generate a large interaction force with the winding disc 138 at the winding positions 1381. As a result, the cable 900 can be tortuously wound on the winding disc 138, is not easy to fall off, and has higher stability.

Referring to FIGS. 32-35, in some embodiments, the winding disc 138 includes a third side surface 1382 and a fourth side surface 1383 opposite to each other. The plurality of winding positions 1381 includes a plurality of threading holes 1381a arranged at intervals. The threading holes 1381a are in communication with the third side surface 1382 and the fourth side surface 1383. The threading hole 1381a is configured for the cable 900 to pass through. After the cable 900 passes through the threading holes 1381a, the cable 900 can be wound on the winding disc 138. In some embodiments, the cable 900 after passing through the threading holes 1381a will be partially located on the third side surface 1382 and partially located on the fourth side surface 1383, and even the cable 900 can form a staggered arrangement on the third side surface 1382 and/or the fourth side surface 1383, thereby strengthening connection and fixation between the cable 900 and the winding disc 138.

Referring to FIG. 32 and FIG. 33, in some embodiments, the winding position 1381 includes a plurality of cable channels 1381e defined on the third side surface 1382 of the winding disc 138. Both ends of a corresponding one of the plurality of cable channels 1381e are in communication with corresponding two of the threading holes 1381a on the third side surface 1382. Thus, the plurality of cable channels 1381e can be configured to accommodate the cable 900, so as to reduce protrusion of the cable 900 on the third side surface 1382 of the winding disc 138 after the cable 900 is wound on the winding disc 138.

Referring to FIG. 34 and FIG. 35, in some embodiments, the winding position 1381 further includes the plurality of cable channels 1381e defined on the fourth side surface 1383 of the winding disc 138. Both ends of a corresponding one of the plurality of cable channels 1381e are in communication with corresponding two of the plurality of threading holes 1381a on the fourth side surface 1383. Thus, the plurality of cable channels 1381e can also be configured to accommodate the cable 900, so as to reduce protrusion of the cable 900 on the fourth side surface 1383 of the winding disc 138 after the cable 900 is wound on the winding disc 138.

Referring to FIGS. 33-35, in some embodiments, a portion of the plurality of cable channels 1381e may extend longitudinally, and another portion of the plurality of cable channels 1381e may extend transversely, thereby achieving the turning angle of the cable 900 equal to 90 degrees, so that the cable 900 can be firmly wound on the winding disc 138, and the cable 900 can also be wound more regularly/orderly, which may facilitate later disassembly or replacement of the cable 900. Referring to FIGS. 33 to 35, in some embodiments, the corresponding one of the plurality of cable channels 1381e may be a groove defined on the third side surface 1382 and/or the fourth side surface 1383. Of course, in other embodiments, the cable channel 1381e may also be a channel enclosed by a convex plate 1381b.

In some embodiments, the winding disc 138 is arc-shaped, the reel body 136 includes a first mounting position 1367, and the winding disc 138 is mounted at the first mounting position 1367; and/or the output device further includes a protective cover 139, the protective cover 139 is covered on the winding disc 138, and a cable outlet 139a is further defined on the protective cover 139 and is configured for the cable 900 to pass through; an outer side of the winding disc 138 or an outer side of the protective cover 139 is tangent to the outer peripheral surface of the reel body 136. For example, referring to FIG. 30, the first mounting position 1367 is a recessed structure on a surface of the reel body 136. The winding disc 138 is mounted on the first mounting position 1367, which can reduce the possibility of the winding disc 138 protruding from the outer peripheral surface of the reel body 136. An arc-shaped structure of the winding disc 138 can enable/make the outer side of the winding disc 138 tangent to the outer peripheral surface of the reel body 136, so that the winding disc 138 mounted on the first mounting position 1367 will not affect the winding of the cable 900 on the reel body 136. In some embodiments, a winding apparatus further includes the protective cover 139. The protective cover 139 can be configured to protect the winding disc 138 and the cable 900 wound on the winding disc 138. After the cable 900 is wound and fixed on the winding disc 138, the cable 900 passes through the cable outlet 139a of the protective cover 139 and then is wound on the outer wall of the reel body 136. In addition, the outer side of the protective cover 139 can also be tangent to the outer peripheral surface of the reel body 136, so that the protective cover 139 will not affect the winding of the cable 900 on the reel body 136.

In some embodiments, a second positioning protrusion is provided on a side of the protective cover 139 facing the winding disc 138/the first mounting position 1367. A second positioning groove is defined on the winding disc 138. The second positioning protrusion and the second positioning groove correspond to each other, which can provide positioning for installation of the protective cover 139. At the same time, the second positioning groove can also be defined at the first mounting position 1367, or can also be defined on both the first mounting position 1367 and the winding disc 138.

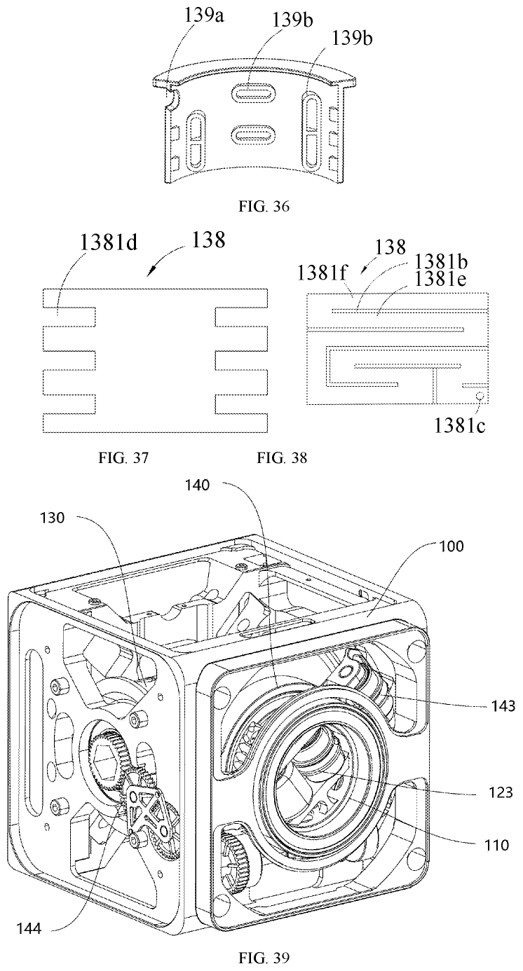

Referring to FIG. 36, in some embodiments, a first protruding portion 139b is arranged at a side of the protective cover 139 facing the winding disc 138. The first protruding portion 139b is configured to press the cable 900. In some embodiments, a position at which the first protruding portion 139b is disposed is matched with a position of winding the cable 900. Thus, when the protective cover 139 is closed, the first protruding portion 139b can further press the cable 900 in the cable channel 1381e, so as to further prevent the cable 900 from loosening and falling off.

In some examples, after the cable 900 is wound and fixed on the winding disc 138, the winding disc 138 can be fixed to the reel body 136 by a screw. After the protective cover 139 is covered on the winding disc 138, the winding disc 138 can also be fixed to the reel body 136 by a screw or a snap.

In some embodiments, a second protruding portion is provided on a side of the first mounting position 1367 facing the winding disc 138. The second protruding portion is configured to press the cable 900. In some embodiments, a position at which the second protruding portion is disposed is matched with the position of winding the cable 900. Thus, when the winding disc 138 is fixed in the first mounting position 1367, the second protruding portion will press the cable 900 in the cable channel 1381e.

In addition, in some embodiments, when the protective cover 139 also covers the winding disc 138, the winding disc 138 can be fully fixed in the first mounting position 1367, and a first side and a second side of the winding disc 138 can be respectively pressed against by the protective cover 139 and the reel body 136. At the same time, the cable 900 in the cable channel 1381e is respectively pressed by the first protruding portion 139b and/or the second protruding portion.

In some embodiments, referring to FIG. 33 and FIG. 35, when in use, the user passes an end of the cable 900 through the plurality of threading holes 1381a in sequence, and the cable 900 is correspondingly accommodated in the plurality of cable channels 1381e. Then, the winding disc 138 with the cable 900 wound thereon is mounted at the first mounting position 1367 by a screw or a snap-fit, and the second protruding portion on the first mounting position 1367 presses and fixes the cable 900 in the cable channel 1381e on the fourth side surface 1383. Then, the protective cover 139 is covered on the winding disc 138, and the remaining portion of the cable 900 passes through the cable outlet 139a of the protective cover 139, and then the protective cover 139 is mounted on the reel body 136 by the screw or the snap-fit. At this time, the first protruding portion 139b on the protective cover 139 presses and fixes the cable 900 in the cable channel 1381e on the third side surface 1382, and finally, the remaining portion of the cable 900 is wound on the outer wall of the reel body 136.

Referring to FIG. 37, in some embodiments, the winding position 1381 includes a plurality of notches 1381d defined on opposite sides of the winding disc 138, which may allow the end portion of the cable 900 to be wound in sequence. It can be understood that, in an embodiment, the winding disc 138 can be in a fishbone-like structure. When winding the cable 900, the user passes the cable 900 through a corresponding one of the notches 1381d at one end of the winding disc 138, and then passes the cable 900 through another corresponding one of the notches 1381d at the opposite end of the winding disc 138. Thus, the cable 900 is repeatedly passed through the notches 1381d at the opposite ends, so that the cable 900 can be wound on the winding disc 138. In some embodiments, the cable 900 is wound on the winding disc 138 multiple times, and some of the cable 900 can be staggered and overlapped, so that the cable 900 wound on an outer ring may also squeeze/press the cable 900 wound on an inner ring, thereby further making the cable 900 wound on the winding disc 138 more stable and firm.

In some embodiments, the corresponding one of the plurality of cable channels 1381e can also be defined between two adjacent of the plurality of notches 1381d. For example, a groove is defined, so that the winding of the cable 900 does not protrude from a surface of the winding disc 138.

Referring to FIG. 38, in some embodiments, the winding disc 138 includes the third side surface 1382 and the fourth side surface 1383 opposite to each other. At least one of the cable channels 1381e is defined on the third side surface 1382 and/or the fourth side surface 1383 of the winding disc 138, and is configured to accommodate the cable 900. Referring to FIG. 38, in some embodiments, the winding disc 138 further includes a base plate 1381f and a plurality of convex plates 1381b. The plurality of convex plates 1381b are provided on the base plate 1381f and protrude toward the third side surface 1382 or the fourth side surface 1383. The cable channel 1381e is defined between two adjacent of the plurality of convex plates 1381b. The cable 900 can be staggeredly wound and fixed on the plurality of convex plates 1381b through the cable channel 1381e. In other embodiments, a through slot or through groove may also be defined on the third side surface 1382 and/or the fourth side surface 1383 of the winding disc 138, and the cable channel 1381e is defined by the through slot.

In some embodiments, the cable channel 1381e extends in a zigzag pattern, so that the cable 900 can form a bent or curved path when passing through the cable channel 1381e. Therefore, the cable 900 can be wound on the winding disc 138 in a more curved or staggered manner, resulting in a firmer winding.

In some embodiments, at least one of the cable channels 1381e is respectively defined on the third side surface 1382 and the fourth side surface 1383 of the winding disc 138. At least one fifth through via 1381c is also defined on the winding disc 138 or at least one of the notches 1381d is also defined at a side, and the at least one fifth through via 1381c or the at least one of the notches 1381d is in communication with the cable channels 1381e on the third side surface 1382 and the fourth side surface 1383. Thus, after the cable 900 is wound on the winding disc 138 on the third side surface 1382, the cable 900 can pass through the fifth through via 1381c to the fourth side surface 1383, so that the cable 900 can continue to be wound on the fourth side surface 1383. In some embodiments, the winding disc 138 may not define the fifth through via 1381c, and at least one of the notches 1381d is defined at the side. When the cable 900 is wound on the third side surface 1382, the cable 900 may be wound from the at least one of the notches 1381d of the winding disc 138 to the fourth side surface 1383.

Some embodiments of the present disclosure further provide a fitness device, including the winding reel 130 according to any one of the foregoing embodiments. In some examples, the fitness device may be a rowing exercise machine, or the output device according to any one of the foregoing embodiments. During use, a user repeatedly pulls the cable 900 to achieve a fitness purpose, and the fitness device including the winding device 100 can reduce the possibility of the cable 900 easily coming off, which may provide better stability and higher safety.

Referring to FIGS. 39-48, in an embodiment of the present disclosure, a cable arranging and winding mechanism is disclosed, which is arranged in the cable housing 100. The cable arranging and winding mechanism includes a winding reel 130, a cable-arranging assembly 140 and a linkage/drive assembly 144. The winding reel 130 is rotatably disposed on the cable housing 100, and the cable-arranging assembly 140 is movably disposed on the cable housing 100. The linkage assembly 144 is connected to the winding reel 130 and the cable-arranging assembly 140, and enables the winding reel 130 and the cable-arranging assembly 140 to be linked. When in use, the cable 900 is wound on the winding reel 130, an end of the cable 900 is fixed on the winding reel 130, and the other end of the cable 900 passes through the cable-arranging assembly 140 and exits from the cable housing 100 through a cable outlet 110.

During operation, taking releasing the cable 900 as an example, the cable 900 is pulled, and at the same time, the winding reel 130 rotates to release the cable. The winding reel 130 rotates to drive the cable-arranging assembly 140 to move via the linkage assembly 144, and the cable-arranging assembly 140 moves synchronously with a position where the cable 900 is released from the winding reel 130, i.e., with a position of releasing the cable 900 from the winding reel 130. For example, if the cable 900 on the winding reel 130 is wound from left to right, the position where the cable 900 is released from the winding reel 130 is from the right to the left (i.e., a direction of releasing the cable 900 from the winding reel 130 is from the right to the left), and the cable-arranging assembly 140 moves synchronously from the right to the left, that is, a movement direction of the cable-arranging assembly 140 is consistent with the direction of releasing the cable 900 from the winding reel 130, so that the cable 900 on the winding reel 130 can be guided by the cable-arranging assembly 140, thereby achieving orderly releasing the cable 900. The cable 900 after releasing exits from the cable housing 100 through the cable outlet 110, which may maintain stable releasing the cable 900 at a fixed position. Taking winding/retracting the cable 900 as an example, the winding reel 130 rotates to drive the cable 900 to wind/retract, and at the same time, the winding reel 130 drives the cable-arranging assembly 140 to move via the linkage assembly 144. At this time, the cable-arranging assembly 140 moves synchronously with a position where the cable 900 is wound/retracted on the winding reel 130, i.e., with a position of winding or arranging the cable 900 on the winding reel 130. For example, if the cable 900 on the winding reel 130 is wound from left to right, the position where the cable 900 is wound or arranged on the winding reel 130 is from the left to the right (i.e., a direction of winding or arranging the cable 900 on the winding reel 130 is from the left to the right), and the cable-arranging assembly 140 moves synchronously from the left to the right, that is, the movement direction of the cable-arranging assembly 140 is consistent with the cable-arranging direction of winding the cable 900 on the winding reel 130, so that the cable 900 retracted through the cable outlet 110 can be guided by the cable-arranging assembly 140, thereby achieving orderly cable winding. The cable 900 after cable winding is stably wound on the winding reel 130, and the cable 900 that has not been wound is retracted in sequence at a fixed position, i.e., at the cable outlet 110.

By configuring the linkage assembly 144 and the cable-arranging assembly 140, ordered winding and releasing of the cable 900 on the winding reel 130 can be automatically achieved by utilizing the rotation of the winding reel 130 when the winding reel 130 releases the cable. At the same time, the cable outlet 110 located at a fixed position of the cable housing 100, can prevent the cable leaving the winding reel 130 from being affected by the cable-arranging assembly 140.

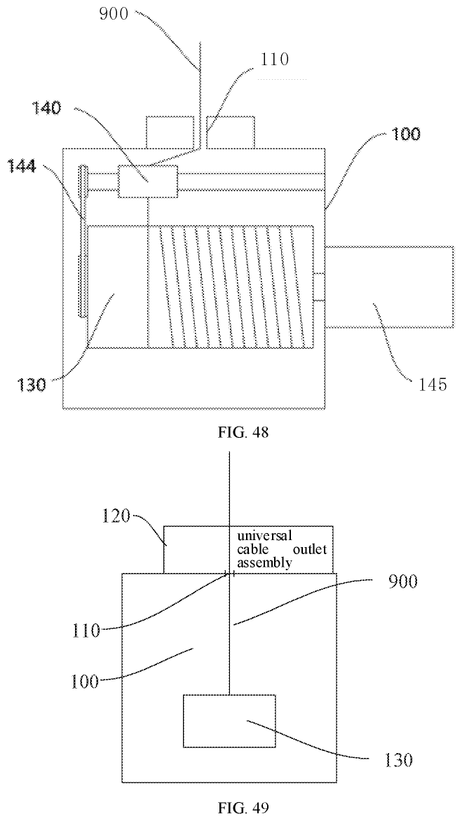

In some embodiments, as shown in FIG. 48, some embodiments of the present disclosure also disclose a cable arranging and winding mechanism, and the cable arranging and winding mechanism includes the cable housing 100, the winding reel 130, the cable-arranging assembly 140 and a power actuator 145. The winding reel 130 is rotatably arranged on the cable housing 100, the cable-arranging assembly 140 is movably arranged on the cable housing 100, and the power actuator 145 is configured to drive the cable-arranging assembly 140 to move. When in use, the cable 900 is wound on the winding reel 130, an end of the cable 900 is fixed on the winding reel 130, and the other end of the cable 900 passes through the cable-arranging assembly 140 and passes through the cable housing 100 via the cable outlet 110.

During operation, when the winding reel 130 releases or winds the cable 900, the power actuator 145 drives the cable-arranging assembly 140 to move in the same direction. For example, the cable 900 is wound from left to right. When the winding reel 130 releases the cable 900, the direction of releasing the cable 900 from the winding reel 130 is from right to left. At this time, the power actuator 145 drives the cable-arranging assembly 140 to move from right to left, so as to guide the cable 900 at the releasing position through the cable-arranging assembly 140, which may enable the cable 900 to smoothly pass through the cable outlet 110. For example, the cable 900 is wound from left to right of the winding reel 130. When the winding reel 130 winds the cable 900, the direction of winding the cable 900 on the winding reel 130 is from left to right. At this time, the power actuator 145 drives the cable-arranging assembly 140 to move from left to right, which may ensure that the cable 900 can not be repeatedly wound with each other, and reduce the possibility of the cable 900 being entangled and knotted on the winding reel 130.

By configuring the power actuator 145 and the cable-arranging assembly 140, the power actuator 145 can be configured to drive the cable-arranging assembly 140 to move when the winding reel 130 releases and winds the cable 900, so as to achieve ordered winding and releasing of the cable 900 on the winding reel 130. At the same time, the cable outlet 110 located at the fixed position of the cable housing 100 can prevent the cable leaving the winding reel 130 from being affected by the cable-arranging assembly 140, or enable the irregular cable 900 to be released/unwound orderly at the fixed position and then arranged neatly on the winding reel 130.

The concept of the cable housing 100 only refers to providing installation and positioning for the winding reel 130, the cable-arranging assembly 140, the linkage assembly 144, the power actuator 145 and the cable outlet 110. The cable housing 100 can be a single component or a combination of a plurality of components fixed to each other. The movement of the cable-arranging assembly 140 in some embodiments of the present disclosure can be translation or pivoting, which is not limited herein. The linkage assembly 144 can be a gear transmission via a gear set, or a belt transmission or a chain transmission, or a worm 1443/worm gear transmission, or a crank-slider assembly, or a crank rocker assembly or other contact transmission modes, or a non-contact force transmission (for example, through magnetic transmission, etc.); and any transmission mode in the related art is included therein. The power actuator 145 can be a motor 500, or an electric push shaft, or other mechanical motion power sources such as hydraulic or pneumatic power sources, which can also include a transmission assembly for transmitting power from the power source to the cable-arranging assembly 140, and any power source or any integrated assembly of a power source and a transmission assembly in the related art that can transmit power to the cable-arranging assembly 140 for movement is included.

In some embodiments, as shown in FIGS. 39-43, the cable-arranging assembly 140 is pivotably arranged on the cable housing 100, and a pivot point of the cable-arranging assembly 140 is the cable outlet 110. Since the cable-arranging assembly 140 pivots about the cable outlet 110, a distance between a position where the cable 900 passes through the cable-arranging assembly 140 and the cable outlet 110 is constant, that is, the cable-arranging assembly 140 pivots to any position without affecting movement of this section of the cable 900, which may improve the stability of the cable-arranging assembly 140.

In some embodiments, the cable-arranging assembly 140 includes a pivoting seat 1411 and a cable-guiding arm 1412 connected to each other. The pivoting seat 1411 is rotatably disposed on the cable housing 100 around the cable outlet 110, and the cable-guiding arm 1412 is configured for the cable 900 to pass through. An angle detection assembly configured to detect a pivot angle of the cable-arranging assembly 140 is also provided. The pivot angle of the cable-arranging assembly 140 can be calculated via an angle detection apparatus 1413. Since a transmission ratio of the linkage assembly 144 and a diameter of the winding reel 130 are both constants, the number of revolutions of the winding reel 130 can be obtained by calculating the pivot angle, and then working status of releasing and winding can be obtained, such as working progress of releasing or winding, or a length of the cable 900 that has been wound or unwound, etc.

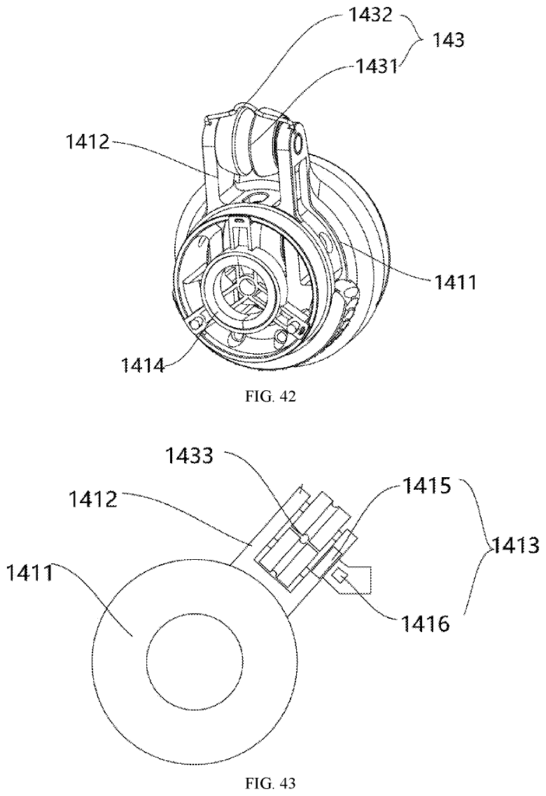

In some embodiments, as shown in FIG. 42, the angle detection apparatus 1413 may include a magnetic ring 1414 provided on the pivoting seat 1411, that is, when the pivoting seat 1411 rotates, a pivoting Hall sensor 1416 fixed on the cable housing 100 can detect change of magnetic field strength, and a pivot angle of the pivoting seat 1411 can be obtained according to magnitude of the magnetic field strength. As shown in FIG. 43, the angle detection apparatus 1413 can also include a magnetic member 1415 provided on the cable-guiding arm 1412 and a pivoting Hall sensor 1416 provided on the cable housing 100. When the cable-guiding arm 1412 rotates with the pivoting seat 1411, the pivoting Hall sensor 1416 fixed on the cable housing 100 can also sense the change of magnetic field strength, and the pivot angle of the pivoting seat 1411 and the cable-guiding arm 1412 can be obtained according to magnitude of the magnetic field strength.

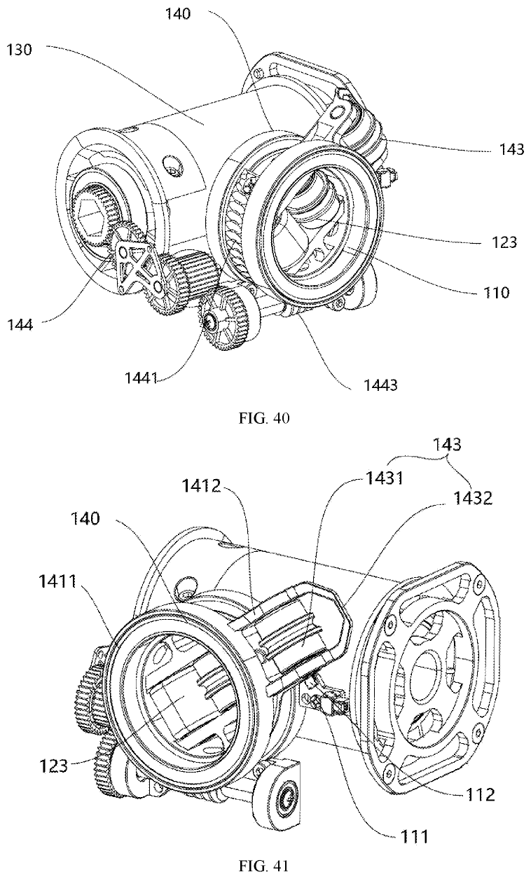

In some embodiments, as shown in FIGS. 40-41, the linkage assembly 144 includes a self-locking worm wheel 1441 and a worm 1443. The winding reel 130 drives the self-locking worm wheel 1441 on the pivoting seat 1411 to rotate through the worm 1443. By utilizing the self-locking effect of the self-locking worm wheel 1441 and the worm 1443, one-way transmission of the worm 1443 to the worm wheel can be achieved, and self-locking of the worm wheel to the worm 1443 can be achieved at the same time, which can prevent the pivoting seat 1411 from rotating incorrectly due to gravity, impact or other reasons and thus driving the winding reel 130 to rotate for unwinding/releasing.

The self-locking worm wheel 1441 includes a complete full-circle worm wheel, or may also be an incomplete partial worm wheel, as long as the arrangement of worm wheel teeth of the worm wheel satisfies the pivoting stroke.

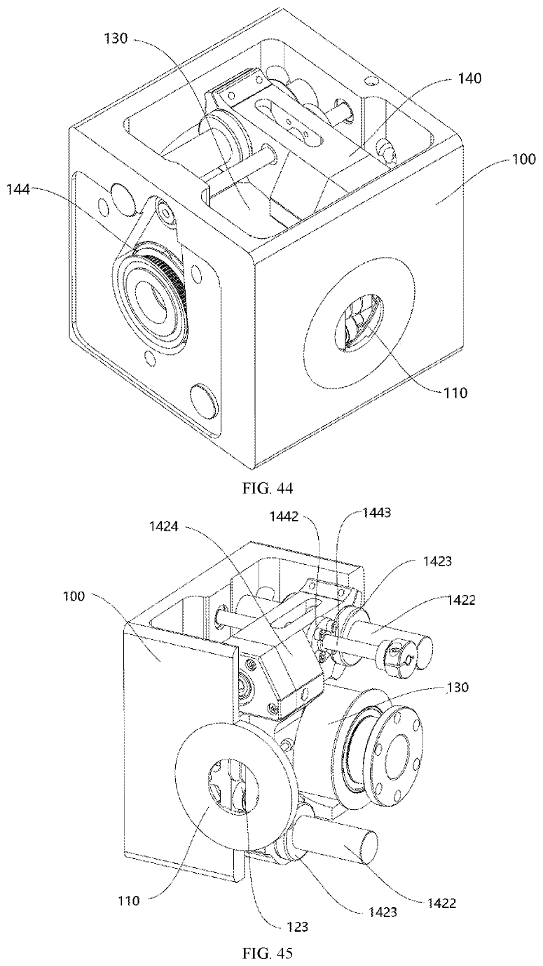

In some embodiments, as shown in FIGS. 44-46, the cable-arranging assembly 140 is slidably disposed on the cable housing 100, and a sliding direction is substantially parallel to an axial direction of the winding reel 130. When the winding reel 130 releases/unwinds or winds the cable 900, a movement of the position of releasing the cable 900 and a movement of the position of winding the cable 900 are substantially parallel to an axis of the winding reel 130. By configuring the cable-arranging assembly 140 in the same direction, the position of releasing the cable 900, the position of winding the cable 900, and the cable-arranging assembly 140 remain relatively stationary during releasing or winding, further improving stability.

In some embodiments, as shown in FIG. 45, the cable-arranging assembly 140 includes a sliding base 1421 slidably disposed on the cable housing 100, and a cable-guiding assembly 1424 disposed on the sliding base 1421 and configured for the cable 900 to pass through. A guide shaft 1422 is disposed on the cable housing 100 along a direction parallel to an axial direction of the winding reel 130, and the sliding base 1421 is configured to be slidable on the guide shaft 1422 through a linear bearing 1423. The arrangement of the guide shaft 1422 and the linear bearing 1423 can reduce a sliding resistance of the sliding base 1421, which may improve the sliding precision of the sliding base 1421. At the same time, the guide shaft 1422 and the linear bearing 1423 can provide stable support for the sliding base 1421. In some embodiments, there are at least two guide shafts 1422 and at least two sliding bases 1421, and two sets of guide shafts 1422 can provide more stable support for the cable housing 100.

In some embodiments, the linkage assembly 144 includes a worm 1443 and a self-locking worm gear nut 1442. The worm 1443 is in transmission connection with the winding reel 130, and the worm gear nut is disposed on the sliding base 1421. Rotation of the winding reel 130 drives the worm 1443 to rotate, thereby driving the self-locking worm gear nut 1442 and the sliding base 1421 to translate/move along the worm 1443. The self-locking worm gear nut 1442 can also achieve one-way transmission from the worm 1443 to the self-locking worm gear nut 1442, and achieve self-locking of the self-locking worm gear nut 1442 to the worm 1443 at the same time, thereby preventing the sliding base 1421 from rotating incorrectly due to gravity, impact or other reasons and thus driving the winding reel 130 to rotate for releasing.

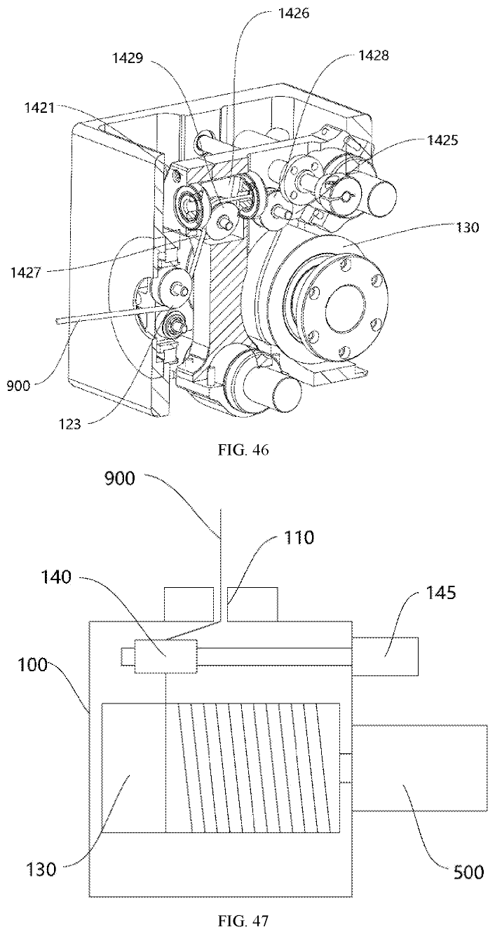

In some embodiments, as shown in FIG. 46, the cable-guiding assembly 1424 includes a cable-arranging port or cable winding port 1425 disposed on the sliding base 1421, and a rotating base 1426 located at a rear side of the cable-arranging port 1425 and rotatably disposed on the sliding base 1421 around a cable outgoing/outlet direction of the cable-arranging port 1425. The rotating base 1426 includes a threading channel and a direction-changing port 1427. The threading channel is defined on the rotating base 1426 along a rotating axis direction. The direction-changing port 1427 is disposed on the rotating base 1426 and in communication with the threading channel. The direction-changing port 1427 is tangent to a rotating axis of the rotating base 1426, and the cable 900 sequentially passes through the cable-arranging port 1425, the threading channel and the direction-changing port 1427, and finally exits from the cable outlet 110.

The cable-arranging port 1425 is disposed on the sliding base 1421 opposite to the winding reel 130, and the cable-arranging port 1425 includes a cable incoming direction entering from the winding reel 130 and a cable outgoing/outlet direction leaving the cable-arranging port 1425 and entering the threading channel of the rotating base 1426.

During operation, as the sliding base 1421 slides along the guide shaft 1422, positions of the cable-guiding assembly 1424 and the cable outlet 110 will inevitably change, resulting in changes in a relative distance and a relative angle between the cable-guiding assembly 1424 and the cable outlet 110. In an embodiment, by providing the rotating base 1426 and utilizing the tension on the cable 900, the rotating base 1426 can adaptively adjust an angle of the rotating base 1426 with the change in a relative position between the cable-guiding assembly and the cable outlet 110, so that the direction-changing port 1427 of the rotating base 1426 is in some cases aligned with the cable outlet 110, thereby preventing cable jumping phenomenon caused by excessive change in the relative position between the cable-guiding assembly 1424 and the cable outlet 110.

In some embodiments, a first direction-changing wheel 1428, such as a first direction-changing pulley, may further be disposed at the cable-arranging port 1425 in the cable-guiding assembly 1424, and the first direction-changing wheel 1428 is tangent to a rotating axis direction of the rotating base 1426. In some embodiments, a second direction-changing wheel 1429, such as a second direction-changing pulley, may further be disposed at the direction-changing port 1427 in the cable-guiding assembly 1424, and the second direction-changing wheel 1429 is tangent to the rotating axis direction of the rotating base 1426. That is, by providing the first direction-changing wheel 1428 and the second direction-changing wheel 1429, sliding of the cable 900 relative to the cable-guiding assembly 1424 is converted into rolling, thereby reducing frictional resistance and wear.

In some embodiments, as shown in FIG. 46, a cable outlet wheel 123, such as a cable outlet pulley, is disposed at the cable outlet 110, which can reduce the wear of the cable 900 passing through the cable outlet 110. In some embodiments, the cable outlet wheel 123 is a pair of wheels, and at least one of the cable outlet wheels 123 is provided with rotational damping. By providing the rotational damping, the cable 900 can have a certain tension when releasing or winding the cable 900, so that the cable 900 is tightened. The rotational damping for the cable outlet wheel 123 can be directly provided for rotation of the cable outlet wheel 123.

In some embodiments, the transmission ratio of the linkage assembly 144 can be reasonably set, so that when the winding reel 130 rotates one revolution, the linkage assembly 144 is configured to drive the threading port of the cable-arranging assembly 140 to translate or pivot a distance corresponding to a diameter of the cable 900, further improving precision of winding and releasing the cable 900.

In some embodiments, when the winding reel 130 rotates in the same direction, the linkage assembly 144 drives the cable-arranging assembly 140 to pivot or slide from one end of the winding reel 130 to the other end of the winding reel 130, achieving orderly releasing or winding of the cable 900 from one end of the winding reel 130 to the other end of the winding reel 130. In some embodiments, as the length of the cable 900 increases, it may be useful to make full use of the winding reel 130 to perform multilayer cable arrangement on the winding reel 130. At this time, when the winding reel 130 rotates in the same direction, the linkage assembly 144 drives the cable-arranging assembly 140 to pivot or slide back and forth between the two ends of the winding reel 130, i.e., between one end of the winding reel 130 and the other end of the winding reel 130, so that when arranging each layer of cable 900, the cable-arranging assembly 140 can be configured for limited releasing or winding from one end of the winding reel 130 to the other end of the winding reel 130. The linkage assembly 144 can adopt any transmission assembly in the related art configured to achieve reciprocating motion (e.g., a cylindrical cam, an end cam, a crank-slider assembly).

In some embodiments, as shown in FIG. 43, the cable housing 100 is further provided with a third limiting structure 111, and the third limiting structure 111 is configured to limit a limit position of the cable-arranging assembly 140. The third limiting structure 111 limits the limit position of the movement of the cable-arranging assembly 140, preventing incorrect cable-arranging of the cable 900 caused by the cable-arranging assembly 140 exceeding the limit position. In some embodiments, the third limiting structure 111 is further provided with a micro switch 112. When the cable-arranging assembly 140 moves to the limit position, the micro switch 112 is triggered, and the micro switch 112 can send an electrical signal, which indicates that the cable-arranging assembly 140 has moved to the third limiting structure 111. The electrical signal can be configured to warn the limit position of the cable-arranging assembly 140 or make corresponding responses, such as stopping releasing and winding the cable 900.

In some embodiments, as shown in FIGS. 39-43, the cable-arranging assembly 140 includes a guiding assembly 143, and the guiding assembly 143 is configured for the cable 900 to pass through. The guiding assembly 143 can guide the cable 900, and a cable-guiding wheel 1431, such as a cable-guiding pulley, can be used in the guiding assembly 143 to reduce friction and wear when the cable 900 passes through the guiding assembly 143. In some embodiments, the guiding assembly 143 is further provided with a cable retention bracket 1432 in addition to the cable-guiding wheel 1431. The cable retention bracket 1432 can be a larger frame or a smaller frame that is shaped like the cable 900. The cable retention bracket 1432 is configured to limit the cable 900 on the cable-guiding wheel 1431, which may help reduce the possibility of the cable 900 contacting other structures except the cable-guiding wheel 1431. In some embodiments, as shown in FIG. 42, the guiding assembly 143 includes a pair of cable-guiding wheels 1433, and each of the pair of cable-guiding wheels 1433 defines a third cable groove. At this time, the cable 900 passes through the third cable grooves at a tangent position of the pair of cable-guiding wheels 1433. A space defined by two third cable grooves at the tangent position can limit a position of the cable 900, which may help reduce the friction between the cable 900 and other structures.

In some embodiments, a motion detection apparatus is further included, and the motion detection apparatus is configured to detect a current motion position of the cable-arranging assembly 140. By detecting the current motion position of the cable-arranging assembly 140 and combining with a pre-known parameter such as a transmission ratio of the linkage assembly 144, the diameter of the winding reel 130, or the diameter of the cable 900, it is possible to determine the number of revolutions of the winding reel 130 when releasing or winding the cable 900, a length of the cable 900 when releasing the cable 900, a length of the cable 900 when winding the cable 900, and an arrangement position of the cable 900 on the winding reel 130, etc., may be inferred.

In some embodiments, when the cable-arranging assembly 140 pivots, the motion detection apparatus may be the magnetic ring 1414 or the magnetic member 1415 in some of the foregoing embodiments. When the cable-arranging assembly 140 slides, the motion detection apparatus may include the magnetic member 1415 disposed on the sliding base 1421, and the pivoting Hall sensor 1416 disposed on the cable housing 100. By detecting magnetic field strength of the magnetic member 1415 via the pivoting Hall sensor 1416, a motion state of the sliding base 1421 and the cable-arranging assembly 140 can be known.

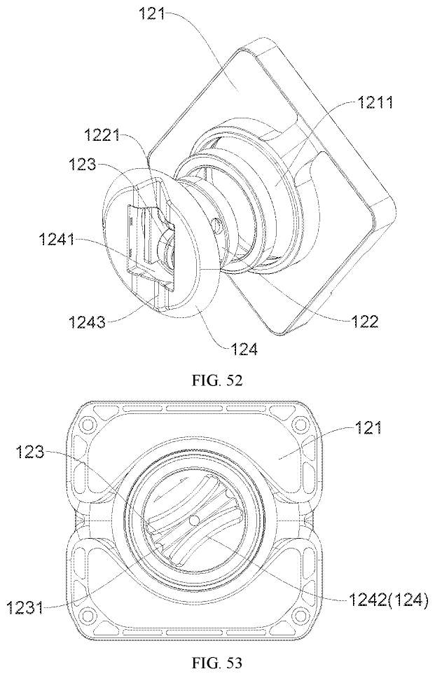

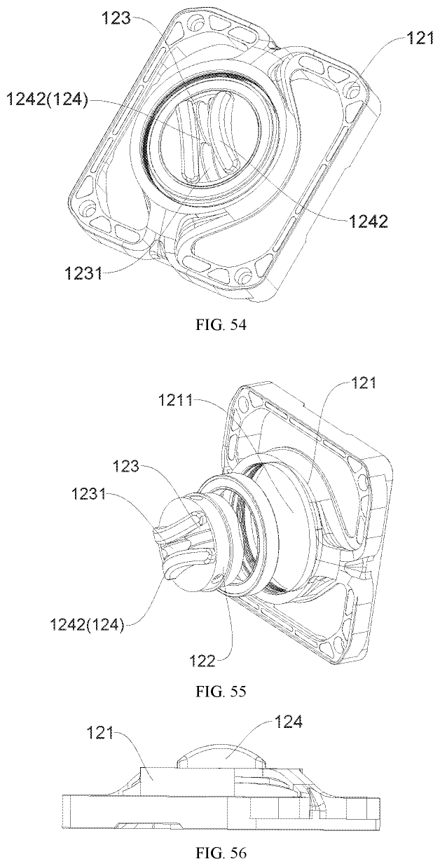

Referring to FIGS. 49-58, an embodiment of the present disclosure discloses a universal cable outlet assembly, which includes a base 121, a rotating base 122, a cable outlet wheel 123, and a cable outlet seat or a cable-guiding seat 124. The base 121 is configured to connect with an output device, and a first channel 1211 is defined in the middle of the base 121. The rotating base 122 is rotatably disposed on the base 121, and a second channel 1221 is defined on a central axis of the rotating base 122. The second channel 1221 is in communication with the first channel 1211. The cable outlet wheels 123 are arranged in pairs on the rotating base 122, and the cable outlet wheels 123 are arranged in pairs along a first direction. The middle of the paired cable outlet wheels 123 is in communication with the second channel 1221. The cable outlet seat 124 is provided on the rotating base 122 and located on a side of the rotating base 122 away from the base 121. The cable outlet seat 124 defines a strip-shaped cable outlet hole 1241, and the cable outlet hole 1241 extends along the first direction. The first channel 1211, the second channel 1221, and the cable outlet hole 1241 are sequentially communicated.

During operation, the cable 900 passes through the first channel 1211 of the base 121, and then sequentially passes through the second channel 1221 and the cable outlet hole 1241. When the cable 900 is unwound or wound along a direction substantially perpendicular to the first channel 1211, the cable 900 will not interact with the cable outlet wheel 123 or the cable outlet seat 124, nor will the cable 900 be worn. When a direction of releasing the cable 900 or a direction of winding the cable 900 changes, the cable 900 will first rest on the cable outlet seat 124 and interact with the cable outlet seat 124. At this time, a force applied by the cable 900 to the cable outlet seat 124 will drive the cable outlet seat 124 to rotate. When the cable outlet seat 124 rotates, a direction of the cable outlet wheel 123 relative to the cable 900 will also change. When the cable outlet seat 124 rotates until the cable 900 rests on the cable outlet wheel 123, a stable cable extension state or cable releasing state is entered. The cable outlet seat 124 is no longer in contact with the cable 900, and the cable 900 will not generate a rotational force on the cable outlet seat 124. At this time, a projection of the cable 900 on the cable outlet seat 124 is the same as an arrangement direction of the cable outlet wheel 123, both of which are the first direction, so that the cable 900 can be stably released or wound through the cable outlet wheel 123.

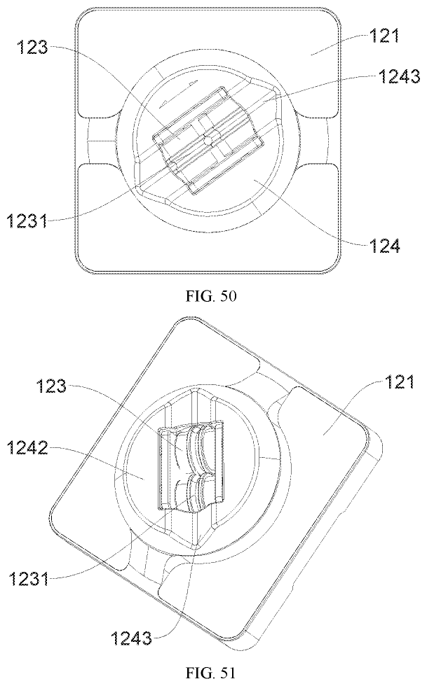

The division between the rotating base 122 and the cable outlet seat 124 is only a functional division, and they can be arranged separately or integrally formed. As shown in FIG. 50 or FIG. 53, the first direction is a direction substantially perpendicular to an axis of a corresponding one of the cable outlet wheels 123 in a plane where axes of the paired cable outlet wheels 123 are located. As shown in FIG. 56, the cable outlet seat 124 covers the cable outlet wheel 123 from a lateral side, that is, with reference to a reference plane that passes through the first direction and is substantially perpendicular to the plane where the axes of the cable outlet wheels 123 are located, a projection of the cable outlet seat 124 on the reference plane can be configured to cover a projection of a corresponding one of the cable outlet wheels 123 on the reference plane.

In some embodiments, a contour of the cable outlet seat 124 can be configured to cover a corresponding one of the cable outlet wheels 123 from a lateral side of the cable outlet wheel 123. By providing the cable outlet seat 124 covering the cable outlet wheel 123, contact and friction between the cable 900 and the cable outlet wheel 123 before entering the stable cable extension state can be prevented. At this time, through direct contact between the cable outlet seat 124 and the cable 900, the cable outlet seat 124 can be deflected in the first time, and the stable cable extension state where the cable 900 rests on the cable outlet wheel 123 for releasing can be entered in advance.

In some embodiments, as shown in FIGS. 53-55, the cable outlet seat 124 includes a cable-guiding member 1242, and the cable-guiding member 1242 is arranged in pairs on the rotating base 122 along a second direction. The second direction is substantially perpendicular to the first direction. The two cable-guiding members 1242 are respectively located on both sides of the paired cable outlet wheels 123, and the cable-guiding member 1242 covers the cable outlet wheel 123 from the lateral side. A cable outlet hole 1241 is defined between the two cable-guiding members 1242. The cable outlet hole 1241 can be defined not only by directly opening on the cable outlet seat 124, but also by providing two cable-guiding members 1242, and the cable outlet hole 1241 is defined by the two cable-guiding members 1242. The cable 900 is guided by the cable-guiding member 1242, so that the cable 900 slides to both sides of the cable-guiding member 1242 under guidance of the cable-guiding member 1242, and the cable 900 finally rests on the cable outlet wheel 123 for releasing.

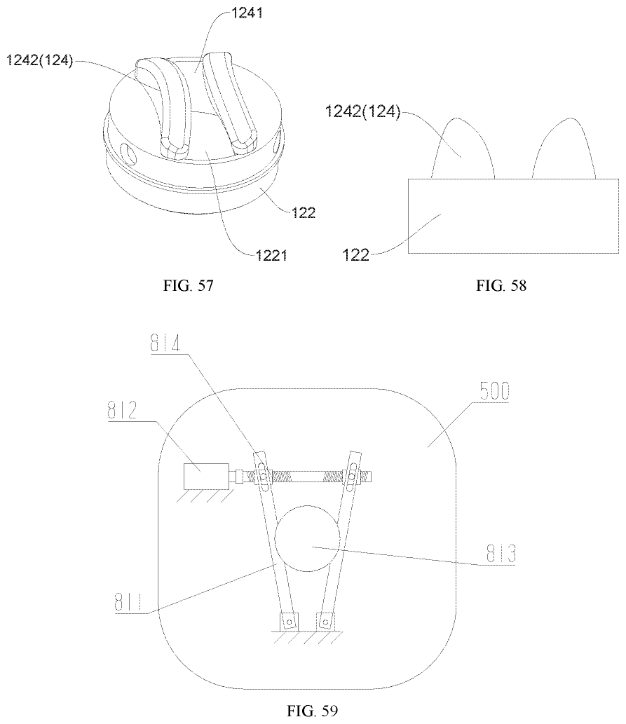

In some embodiments, as shown in FIG. 53, FIG. 57, and FIG. 58, a width of the cable outlet hole 1241 gradually widens from the middle to both sides, that is, both sides of the cable outlet hole 1241 form an arc. When the cable 900 just rests in the middle of the cable outlet hole 1241 of the cable outlet seat 124, the cable 900 will be in an unstable state and will be more likely to slide to both sides of the cable outlet hole 1241. In some embodiments, a width of a middle portion of the cable outlet hole 1241 is approximately the same as the diameter of the cable 900, which may help support that the cable 900 can pass over the middle part of the cable outlet hole 1241, and at the same time, minimize a size of the middle part of the cable outlet hole 1241, which may help reduce probability that the cable 900 gets stuck in the middle part of the cable outlet hole 1241.

In some embodiments, as shown in FIG. 56, a height of the cable-guiding member 1242 gradually decreases from the middle to both sides along the first direction. When the cable 900 rests in the middle of the cable-guiding member 1242, the cable 900 will also be in an unstable state, and thus the cable 900 may be more likely to slide along the first direction to the cable outlet wheel 123 on one side, which may enter the stable cable extension state. In some embodiments, as shown in FIG. 58, the height of the cable-guiding member 1242 gradually increases from the middle to an edge of the cable outlet seat 124 along the second direction, and a curved surface of the cable-guiding member 1242 extending in the second direction is disposed obliquely. When the cable 900 rests on the cable-guiding member 1242, a bending angle of the cable 900 is gentler, a length of interaction between the cable 900 and the cable-guiding member 1242 increases, and interaction relative to the cable-guiding member 1242 decreases, so that the cable 900 can more easily slide on the cable-guiding member 1242 along the first direction and pass through the cable-guiding member 1242 more easily. In some embodiments, as shown in FIG. 57, a paired gap of the cable-guiding members 1242 gradually decreases from the middle to both sides along the first direction, that is, opposite sides of the two cable-guiding members 1242 are both curved, and a spacing in the middle of the opposite sides is the smallest, and the spacing gradually increases from the middle to both sides, so that when the cable rests in the middle of the cable-guiding member 1242, the cable is in an unstable state and more likely to slide to the cable outlet wheel 123 on one side along the first direction. In some embodiments, a distance between middle parts of the cable-guiding members 1242 is approximately the same as the diameter of the cable 900, which may help support the cable 900 can pass over the middle parts of the two cable-guiding members 1242, and at the same time, it may minimize a gap between the middle parts of the two cable-guiding members 1242, which may help reduce probability that the cable 900 gets stuck in the middle parts of the two cable-guiding members 1242.

In some embodiments, a surface of the cable-guiding member 1242 is smoothly curved, so that the cable 900 can be more easily guided by the cable-guiding member 1242 to slide onto the cable outlet wheel 123. In some embodiments, the cable-guiding member 1242 or the cable outlet seat 124 is made of metal. The cable-guiding member 1242 and the cable outlet seat 124 made of metal have a low friction coefficient, which can better guide the cable 900. The metal has a high hardness and is not easy to wear. At the same time, the metal has a good thermal conductivity and can timely dissipate heat generated by friction of the cable 900.

In some embodiments, as shown in FIGS. 50-52, cable outlet grooves 1243 are defined on both sides of the cable outlet seat 124 along the first direction. For example, the cable outlet groove 1243 is configured to avoid the cable 900, so as to prevent unnecessary wear caused by friction between the cable 900 and the cable outlet seat 124 when the cable 900 rests on the cable outlet wheel 123. For example, the cable outlet groove 1243 can also be configured to position the cable 900, so as to improve accuracy of the cable 900 resting on the cable outlet wheel 123, that is, when the cable 900 shifts on the cable outlet wheel 123, the cable outlet grooves 1243 can correct the cable 900.

In some embodiments, at least one of the paired cable outlet wheels 123 is provided with rotational damping, that is, by applying resistance to the cable outlet wheel 123, the cable 900 can maintain a minimum tension when releasing or winding the cable 900, thereby tensioning the cable 900 and making process of releasing or winding more stable.

In some embodiments, as shown in FIGS. 50-55, a first cable groove 1231 is defined around a periphery of the cable outlet wheel 123. The first cable grooves 1231 of the two cable outlet wheels 123 define an annular hole at a tangent position. After the first cable groove 1231 is contoured to the cable 900, when the cable 900 passes through the annular hole defined by the two first cable grooves 1231, the cable 900 will not shift significantly, which may help support stable releasing or winding through the annular hole, thereby limiting a position where the cable 900 passes through a guiding hole or the cable outlet hole 1241, and further improving the stability of releasing or winding.

In some embodiments, the base 121 and the rotating base 122 are rotatably connected via a bearing, so that the rotating base 122 can be more easily driven and rotated by the cable 900.

As shown in FIG. 28, some embodiments of the present disclosure further provide an output device. The output device may include a cable housing 100 and a universal cable outlet assembly 120. The universal cable outlet assembly 120 may be disposed at a cable outlet 110 of the output device. A winding reel 130 may be connected to the cable housing 100, and a cable 900 may be connected to the winding reel 130 and may be configured to pass/extend out of the cable housing 100 through the universal cable outlet assembly 120. The winding reel 130 may be configured to provide power or resistance to the cable 900. The cable 900 can be pulled out from the cable housing 100 or retracted into the cable housing 100. When the cable 900 is pulled out from the cable housing 100 or retracted into the cable housing 100, the winding reel 130 may be configured to apply the resistance or power to the cable 900. By arranging the universal cable outlet assembly 120 at the cable outlet 110 of the cable housing 100, a cable outgoing direction and a cable winding/retraction direction of the output device can be changed, such that it may be possible to enable the cable to be pulled out or retracted/wounded in any direction.

In some embodiments, the power supply assembly 600 may include: the battery 610, fixed on the cable housing 100 and electrically connected to a printed circuit board (PCB) 740 on the cable housing 100; and a display screen 611, fixed on the cable housing 100 and electrically connected to the PCB 740.

In this solution, the battery 610 can supply power to the motor 500 and related components on the PCB 740. The display screen 611 can display working status information of the output device, which may facilitate user operation and use of the output device.

In some embodiments, the display screen 611 may be a touch screen, for example. A user can issue/send a control command by touching the display screen 611, and the output device may operate in response to the control command, which may make it more convenient for the user to operate and use the output device.

In some embodiments, the display screen 611 is located at a side of the battery 610.

In some embodiments, the display screen 611 may be located at a front side of the battery 610, so that the user can easily view the information displayed on the display screen 611.

In some embodiments, the power supply assembly 600 may further include a battery holder 619 fixedly connected to the cable housing 100. Both the battery 610 and the display screen 611 are fixedly connected to the battery holder 619. For example, the battery holder 619 may be fixed to the cable housing 100 via a screw.

In some embodiments, the second unlocking trigger apparatus 6125 may be disposed on the battery holder 619.

In another possible implementation, the second unlocking trigger apparatus 6125 may be disposed on the battery 610. A relief hole corresponding to the second unlocking trigger apparatus 6125 may be defined on the battery holder 619, which may allow the user to directly press or touch the second unlocking trigger apparatus 6125 through the relief hole.

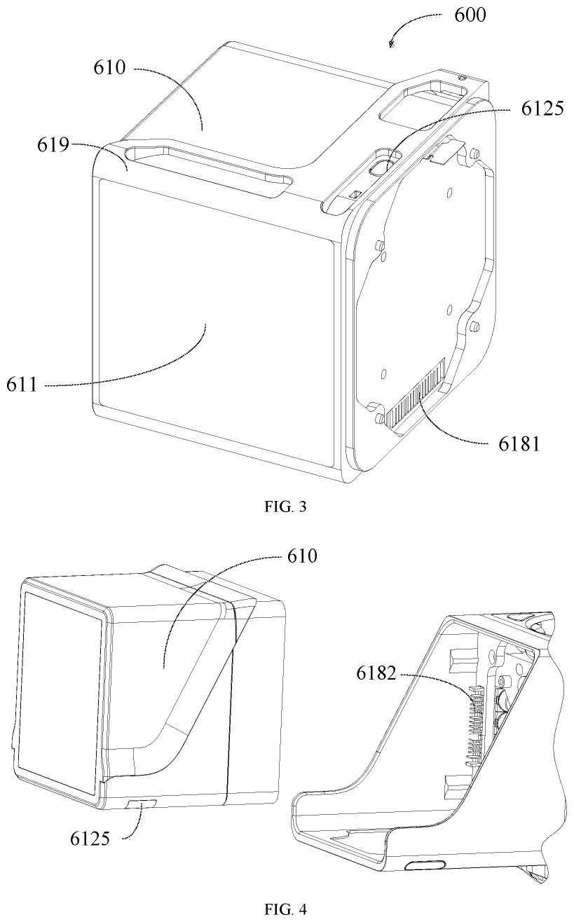

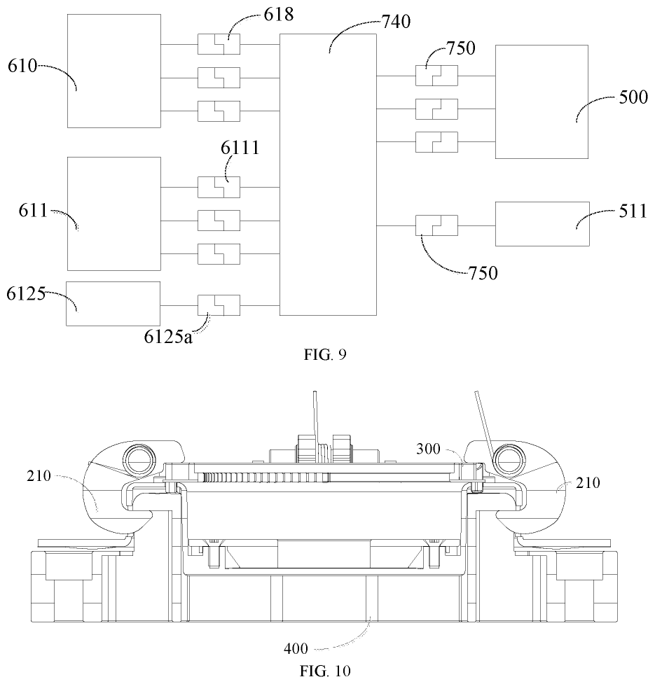

In some embodiments, referring to FIG. 3, FIG. 4, and FIG. 9, the battery 610 is electrically connected to the PCB 740 via a first quick-connect connector 618, thus facilitating quick disassembly of the battery 610.

In some embodiments, the first quick-connect connector 618 may include a first quick-connect sub-connector 6181 and a second quick-connect sub-connector 6182. The first quick-connect sub-connector 6181 is disposed on the battery 610, and the second quick-connect sub-connector 6182 is disposed on the PCB 740. When the battery 610 is mounted, the first quick-connect sub-connector 6181 is inserted into the second quick-connect sub-connector 6182, which may achieve electrical connection between the battery 610 and the PCB 740.

Referring to FIG. 9, the display screen 611 is electrically connected to the PCB 740 via a second quick-connect connector 6111. In this solution, by providing the second quick-connect connector 6111, the display screen 611 can be quickly disassembled.

In some embodiments, referring to FIGS. 7 to 9, the motor 500 is electrically connected to the PCB 740 on the cable housing 100 via a third quick-connect connector 750. In this solution, the third quick-connect connector 750 facilitates quick disassembly of the motor 500, which may make maintenance and repair more convenient.

In some embodiments, referring to FIGS. 7 to 9, the first unlocking trigger apparatus 511 is connected to the PCB 740 on the cable housing 100 via a fourth quick-connect connector 760.

In some embodiments, referring to FIG. 9, the second unlocking trigger apparatus 6125 is connected to the PCB 740 on the cable housing 100 via a fifth quick-connect connector 6125a.

In some embodiments, referring to FIG. 11, the output device may further include a voice sensor communicatively connected to a controller of the output device. The controller is configured to control the motor 500 to operate according to a voice command received by the voice sensor. In this solution, voice control of the output device can be achieved by providing the voice sensor.

Further, referring to FIG. 13, the controller may also be communicatively connected to the display screen 611, and the working status information of the output device (e.g., a current traction force, etc.) may be displayed via the display screen 611, which may facilitate the user to accurately operate the output device as needed.

In some embodiments, the controller is further configured to control the motor 500 to stop operation when the voice command received by the voice sensor exceeds a preset loudness. In this solution, when the user encounters an emergency, the user can stop the motor 500 by transmitting a sound exceeding the preset loudness, thereby improving safety of use.

In some embodiments, referring to FIG. 14, the output device may further include an attitude sensor communicatively connected to the controller of the output device. The controller is configured to determine current motion state information of the output device according to the attitude sensor, and control the motor 500 to operate according to the motion state information. The motion state information includes at least one of a current acceleration of the output device and a current angle of the output device.

In some embodiments, the attitude sensor may be a gyroscope, and the gyroscope may be a mechanical gyroscope or a Micro Electro Mechanical Systems (MEMS). It can be understood that the current acceleration of the output device can be determined by the gyroscope. By continuously tracking the current acceleration of the output device, a current state of the output device, the current angle of the output device, and whether the output device is oscillating, etc., can be determined, so that abnormalities can be discovered in time during the use of the output device, and corresponding measures can be taken.

In some embodiments, if the current acceleration of the output device exceeds a preset acceleration threshold, the output device may accidentally fall off, and the motor 500 can be controlled to stop operation at this time.

In some embodiments, referring to FIG. 15, the output device may further include a first temperature sensor configured to detect the temperature of the motor 500 and communicatively connected to the controller of the output device. The controller is configured to reduce an output power of the motor 500 when it is determined that the temperature of the motor 500 exceeds a preset first temperature threshold.

In this solution, when the temperature of the motor 500 exceeds the preset first temperature threshold, it can reduce the overheating of the motor 500 by reducing the output power of the motor 500. For example, when the temperature of the motor 500 is very high, the motor 500 can be controlled to stop operation immediately. When the temperature of the motor 500 is relatively high, the operation of the motor 500 can be appropriately reduced to decrease the temperature rise of the motor 500.

In some embodiments, the controller is further configured to control a prompt apparatus to issue prompt information when the temperature of the motor 500 exceeds a preset second temperature threshold. The second temperature threshold is less than the first temperature threshold.

In this solution, when the temperature of the motor 500 exceeds the preset second temperature threshold, the prompt apparatus is controlled to issue/send prompt information. The prompt information can be in various forms. For example, voice prompt information can be issued via a loudspeaker or a buzzer to prompt the user that the temperature of the motor 500 is relatively high. Alternatively, the motor 500 can be controlled to generate vibration to prompt the user. Alternatively, display information corresponding to relatively high temperature of the motor 500 can be displayed via the display screen 611. Of course, when the output device is wirelessly connected to a user terminal via Bluetooth or the like, the prompt information can also be pushed to the user terminal.

The prompt information may remind the user to use the motor 500 gently to reduce the temperature rise of the motor 500, or remind the user not to touch the motor 500 to prevent burns, etc., which is not limited herein.

In some embodiments, an angle sensor and/or a revolution sensor can be disposed on a motor shaft, a reel shaft, or any transmission shaft, and configured to record a rotation angle and/or the number of revolutions of the corresponding transmission shaft, and further calculate how long the cable 900 of the current output device has been pulled out based on a transmission ratio between the transmission shaft and the reel shaft, and a periphery of the reel shaft.

In some embodiments, one or more of the technical solutions of the universal cable outlet assembly 120, the technical solution of the winding reel 130 to fix the cable 900, the solution of arranging the cable on the winding reel 130 via the cable-arranging assembly 140, the solution of coupling the connecting structure 200 with the base 400, the solution of the connecting busbar 520 in the motor 500, and the solution of the battery 610 can be applied not only to the output device but also to the corresponding structures of other fitness equipment.

According to a first aspect of the present disclosure, the cable arranging and winding mechanism according to some embodiments of the present disclosure includes: a cable housing; a winding reel, rotatably disposed on the cable housing, and configured to receive a cable wound by the winding reel; a cable-arranging assembly, pivotably disposed on the cable housing, and configured for the cable wound around the winding reel to pass through, where the cable is movable with the cable-arranging assembly; a cable outlet, disposed on the cable housing, and configured for the cable passing through the cable-arranging assembly to pass out; and a linkage assembly or a power actuator, where the linkage assembly is connected to the winding reel and the cable-arranging assembly, the linkage assembly is configured to link the winding reel and the cable-arranging assembly, and the power actuator is configured to drive the cable-arranging assembly to pivot.

In some embodiments, the cable-arranging assembly pivots about the cable outlet. In some embodiments, the cable-arranging assembly includes a pivoting seat and a cable-guiding arm connected to each other, the pivoting seat is rotatably disposed on the cable housing around the cable outlet, and the cable-guiding arm is configured for the cable to pass through.

In some embodiments, the linkage assembly includes: a worm, in transmission connection with the winding reel; and a self-locking worm gear, concentrically disposed on the pivoting seat and meshed with the worm.

In some embodiments, the cable-arranging assembly includes a guiding assembly, and the guiding assembly is configured for the cable to pass through; the guiding assembly includes a cable-guiding wheel; or the guiding assembly includes a cable-guiding wheel and a cable retention bracket, and the cable rests on the cable-guiding wheel and passes through the cable retention bracket; or the guiding assembly includes a pair of cable-guiding wheels, a cable groove is defined on each of the pair of cable-guiding wheels, and the cable is configured to pass through the cable grooves at a tangent position of the pair of cable-guiding wheels.

According to a second aspect of the present disclosure, the cable arranging and winding mechanism according to some embodiments of the present disclosure includes: a cable housing, defining a cable outlet; a winding reel, rotatably disposed on the cable housing, and configured to be wound by the cable; and a cable-arranging assembly, configured to pivot driven by a linkage assembly or a power actuator; where the cable-arranging assembly includes a pivoting seat, a cable-guiding arm, and a guiding assembly, the pivoting seat is rotatably arranged on the cable housing to rotate about the cable outlet, the cable-guiding arm is connected to the pivoting seat, and the guiding assembly is disposed on the cable-guiding arm; the cable is configured to pass through the guiding assembly and exit from the cable outlet; and the guiding assembly is configured to move synchronously with a position where the cable is released from the winding reel or a position where the cable is wound on the winding reel.

In some embodiments, the cable-guiding arm is connected to a periphery of the pivoting seat, and the cable-guiding arm extends radially outward of the pivoting seat.

In some embodiments, the cable-guiding arm includes a first cable-guiding arm and a second cable-guiding arm arranged side by side; and the guiding assembly includes a cable-guiding wheel, and the cable-guiding wheel is disposed between the first cable-guiding arm and the second cable-guiding arm.

In some embodiments, the guiding assembly further includes a cable retention bracket, and the cable retention bracket is disposed at an end of the cable-guiding arm away from the pivoting seat; and the cable retention bracket is configured to limit the cable on the cable-guiding wheel.

In some embodiments, the cable-guiding wheel includes a pair of cable-guiding wheels, a cable groove is defined on each of the paired cable-guiding wheels, and the cable is configured to pass through the cable grooves at a tangent position of the two cable-guiding wheels.

In some embodiments, the cable arranging and winding mechanism further includes: an angle detection apparatus, configured to detect a pivot angle of the cable-arranging assembly.

In some embodiments, the angle detection apparatus includes: a pivoting Hall sensor, disposed on the cable housing; and a magnetic ring, concentrically disposed on the pivoting seat; or a magnetic member, disposed on the cable-guiding arm.

In some embodiments, the linkage assembly includes: a worm, in transmission connection with the winding reel; and a self-locking worm gear, concentrically disposed on the pivoting seat and meshed with the worm.

In some embodiments, the linkage assembly is configured to drive the cable-guiding wheel to pivot by a distance corresponding to a diameter of the cable when the winding reel rotates one revolution.

In some embodiments, when the winding reel rotates in the same direction, the linkage assembly drives the cable-arranging assembly to pivot from one end of the winding reel to the other end of the winding reel; or when the winding reel rotates in the same direction, the linkage assembly drives the cable-arranging assembly to pivot back and forth between two ends of the winding reel.

In some embodiments, the cable housing further includes a limiting structure, and the limiting structure is configured to limit a limit position of the cable-arranging assembly.

In some embodiments, the limiting structure includes a micro switch, and the micro switch is triggered when the cable-arranging assembly moves to the limit position.

In some embodiments, the cable arranging and winding mechanism further includes: a motion detection apparatus, configured to detect a current motion position of the cable-arranging assembly.

In some embodiments, the motion detection apparatus includes a magnetic ring, concentrically disposed on the pivoting seat; or a magnetic member, disposed on the cable-guiding arm.

According to a third aspect of the present disclosure, the output device according to some embodiments of the present disclosure includes: a cable arranging and winding mechanism, including: a cable housing; a winding reel, rotatably disposed on the cable housing, and configured to receive a cable wound by the winding reel; a cable-arranging assembly, pivotably disposed on the cable housing, and configured for the cable wound around the winding reel to pass through, where the cable is movable with the cable-arranging assembly; a cable outlet, disposed on the cable housing, and configured for the cable passing through the cable-arranging assembly to pass out; and a linkage assembly or a power actuator, where the linkage assembly is connected to the winding reel and the cable-arranging assembly, the linkage assembly is configured to link the winding reel and the cable-arranging assembly, and the power actuator is configured to drive the cable-arranging assembly to pivot; a power source, configured to apply power or resistance to the winding reel; and the cable, wound around the winding reel, where an end portion of the cable is configured to pass through the cable-arranging assembly and exit from the cable outlet.

The description with reference to terms such as “an embodiment”, “some embodiments”, “specifically”, or “some examples” means that a specific feature, structure, material, or characteristic described in conjunction with the embodiment or example is included in at least one embodiment or example of the present disclosure. In this specification, the exemplary expressions of the above terms do not necessarily refer to the same embodiment or example. Moreover, the described specific features, structures, materials, or characteristics may be combined in any one or more embodiments or examples in a suitable manner.

Although the embodiments of the present disclosure have been shown and described, those having ordinary skill in the art can understand that various changes, modifications, substitutions, and variations may be made to the embodiments without departing from the principle and spirit of the present disclosure, and the scope of the present disclosure is defined by the claims and their equivalents.

1. A cable arranging and winding mechanism, comprising:
a cable housing;
a winding reel, rotatably disposed on the cable housing, and configured to receive a cable wound by the winding reel;
a cable-arranging assembly, pivotably disposed on the cable housing, and configured for the cable wound around the winding reel to pass through, wherein the cable is movable with the cable-arranging assembly;
a cable outlet, disposed on the cable housing, and configured for the cable passing through the cable-arranging assembly to pass out; and
a linkage assembly or a power actuator, wherein the linkage assembly is connected to the winding reel and the cable-arranging assembly, the linkage assembly is configured to link the winding reel and the cable-arranging assembly, and the power actuator is configured to drive the cable-arranging assembly to pivot.

2. The cable arranging and winding mechanism according to claim 1, wherein the cable-arranging assembly pivots about the cable outlet.

3. The cable arranging and winding mechanism according to claim 2, wherein the cable-arranging assembly comprises a pivoting seat and a cable-guiding arm connected to each other, the pivoting seat is rotatably disposed on the cable housing around the cable outlet, and the cable-guiding arm is configured for the cable to pass through.

4. The cable arranging and winding mechanism according to claim 3, wherein the linkage assembly comprises:
a worm, in transmission connection with the winding reel; and
a self-locking worm gear, concentrically disposed on the pivoting seat and meshed with the worm.

5. The cable arranging and winding mechanism according to claim 1, wherein the cable-arranging assembly comprises a guiding assembly, and the guiding assembly is configured for the cable to pass through;
the guiding assembly comprises a cable-guiding wheel; or
the guiding assembly comprises a cable-guiding wheel and a cable retention bracket, and the cable rests on the cable-guiding wheel and passes through the cable retention bracket; or
the guiding assembly comprises a pair of cable-guiding wheels, a cable groove is defined on each of the pair of cable-guiding wheels, and the cable is configured to pass through the cable grooves at a tangent position of the pair of cable-guiding wheels.

6. A cable arranging and winding mechanism, comprising:
a cable housing, defining a cable outlet;
a winding reel, rotatably disposed on the cable housing, and configured to be wound by the cable; and
a cable-arranging assembly, configured to pivot driven by a linkage assembly or a power actuator;
wherein the cable-arranging assembly comprises a pivoting seat, a cable-guiding arm, and a guiding assembly, the pivoting seat is rotatably arranged on the cable housing to rotate about the cable outlet, the cable-guiding arm is connected to the pivoting seat, and the guiding assembly is disposed on the cable-guiding arm;
the cable is configured to pass through the guiding assembly and exit from the cable outlet; and
the guiding assembly is configured to move synchronously with a position where the cable is released from the winding reel or a position where the cable is wound on the winding reel.

7. The cable arranging and winding mechanism according to claim 6, wherein the cable-guiding arm is connected to a periphery of the pivoting seat, and the cable-guiding arm extends radially outward of the pivoting seat.

8. The cable arranging and winding mechanism according to claim 6, wherein the cable-guiding arm comprises a first cable-guiding arm and a second cable-guiding arm arranged side by side; and
the guiding assembly comprises a cable-guiding wheel, and the cable-guiding wheel is disposed between the first cable-guiding arm and the second cable-guiding arm.

9. The cable arranging and winding mechanism according to claim 8, wherein the guiding assembly further comprises a cable retention bracket, and the cable retention bracket is disposed at an end of the cable-guiding arm away from the pivoting seat; and
the cable retention bracket is configured to limit the cable on the cable-guiding wheel.

10. The cable arranging and winding mechanism according to claim 8, wherein the cable-guiding wheel comprises a pair of cable-guiding wheels, a cable groove is defined on each of the paired cable-guiding wheels, and the cable is configured to pass through the cable grooves at a tangent position of the two cable-guiding wheels.

11. The cable arranging and winding mechanism according to claim 6, further comprising:
an angle detection apparatus, configured to detect a pivot angle of the cable-arranging assembly.

12. The cable arranging and winding mechanism according to claim 11, wherein the angle detection apparatus comprises:
a pivoting Hall sensor, disposed on the cable housing; and
a magnetic ring, concentrically disposed on the pivoting seat; or a magnetic member, disposed on the cable-guiding arm.

13. The cable arranging and winding mechanism according to claim 6, wherein the linkage assembly comprises:
a worm, in transmission connection with the winding reel; and
a self-locking worm gear, concentrically disposed on the pivoting seat and meshed with the worm.

14. The cable arranging and winding mechanism according to claim 8, wherein the linkage assembly is configured to drive the cable-guiding wheel to pivot by a distance corresponding to a diameter of the cable when the winding reel rotates one revolution.

15. The cable arranging and winding mechanism according to claim 6, wherein when the winding reel rotates in the same direction, the linkage assembly is configured to drive the cable-arranging assembly to pivot from one end of the winding reel to the other end of the winding reel; or
when the winding reel rotates in the same direction, the linkage assembly is configured to drive the cable-arranging assembly to pivot back and forth between two ends of the winding reel.

16. The cable arranging and winding mechanism according to claim 6, wherein the cable housing further comprises a limiting structure, and the limiting structure is configured to limit a limit position of the cable-arranging assembly.

17. The cable arranging and winding mechanism according to claim 16, wherein the limiting structure comprises a micro switch, and the micro switch is triggered when the cable-arranging assembly moves to the limit position.

18. The cable arranging and winding mechanism according to claim 6, further comprising:
a motion detection apparatus, configured to detect a current motion position of the cable-arranging assembly.

19. The cable arranging and winding mechanism according to claim 18, wherein the motion detection apparatus comprises a magnetic ring, concentrically disposed on the pivoting seat; or a magnetic member, disposed on the cable-guiding arm.

20. An output device, comprising:
a cable arranging and winding mechanism, comprising:
a cable housing;
a winding reel, rotatably disposed on the cable housing, and configured to receive a cable wound by the winding reel;
a cable-arranging assembly, pivotably disposed on the cable housing, and configured for the cable wound around the winding reel to pass through, wherein the cable is movable with the cable-arranging assembly;
a cable outlet, disposed on the cable housing, and configured for the cable passing through the cable-arranging assembly to pass out; and
a linkage assembly or a power actuator, wherein the linkage assembly is connected to the winding reel and the cable-arranging assembly, the linkage assembly is configured to link the winding reel and the cable-arranging assembly, and the power actuator is configured to drive the cable-arranging assembly to pivot;
a power source, configured to apply power or resistance to the winding reel; and
the cable, wound around the winding reel, wherein an end portion of the cable is configured to pass through the cable-arranging assembly and exit from the cable outlet.
